(19) United States
(12) Patent Application Publication
(10) Pub. No.: US 2016/0170710 A1
(43) Pub. Date: Jun. 16, 2016

(54) METHOD AND APPARATUS FOR PROCESSING VOICE INPUT

(71) Applicant: Samsung Electronics Co., Ltd., Gyeonggi-do (KR)

(72) Inventors: Kyung-Tae KIM, Gyeonggi-do (KR); Tae-Gun PARK, Gyeonggi-do (KR); Yo-Han LEE, Gyeonggi-do (KR); Won-Suk CHOI, Seoul (KR); Eun-Jung HYUN, Seoul (KR)

(21) Appl. No.: 14/967,491

(22) Filed: Dec. 14, 2015

(30) Foreign Application Priority Data
Dec. 12, 2014 (KR) 10-2014-0179249

(51) Int. Cl. G06F 3/16; G10L 15/22; G06F 3/01; G10L 15/26; G10L 17/06

(52) U.S. Cl. CPC G06F 3/167; G10L 15/265; G10L 17/06; G06F 3/017; G10L 15/22; G10L 2015/223; G10L 2015/227

(57) ABSTRACT

Disclosed herein are a method and electronic device. The electronic device includes a first sensor configured for detecting a gesture and a second sensor for detecting a sound, and at least one processor. The processor may implemented the method, including receiving via the first sensor a voice input, detecting via the second sensor a gesture associated with the voice input, selecting at least one content displayed on one or more displays functionally connected with the electronic device based on the detected gesture, determining a function corresponding to the voice input based on the selected content, and executing the determined function.

### CLAIM OF PRIORITY

The present application claims priority under 35 U.S.C. §119 to an application filed in the Korean Intellectual Property Office on Dec. 12, 2014 and assigned Serial No. 10-2014-0179249, the contents of which are incorporated herein by reference.

### TECHNICAL FIELD

Example embodiments of the present disclosure relate to a method for processing an input, and more particularly, to a method and apparatus for processing a voice input using a content.

### BACKGROUND

With the development of electronic technology, electronic devices are developing into various types of devices such as wearable devices which can be worn on or implanted in a part of a user's body like an electronic watch (for example, a smart watch), and a Head-Mounted Display (HMD) (for example, electronic glasses), as well as portable devices which are carried by users like a tablet Personal Computer (PC) and a smartphone. Various types of electronic devices may be communicatively connected with neighboring electronic devices using short-distance communication or long-distance communication. The electronic device may control a neighboring device connected therewith or interact with a neighboring device in response to a user's command.

In addition, the electronic device may provide functions corresponding to various user inputs. For example, the electronic device may recognize a user's voice input using an audio input module (for example, a microphone), and may perform a control operation corresponding to the voice input (for example, making a call, retrieving information, etc.). In addition, the electronic device may recognize a user's gesture input using a camera and may perform a control operation corresponding to the gesture input.

The electronic device (for example, a smartphone) may perform a function different from a user's intention in response to a user's voice input. For example, when information is retrieved based on a search term which is inputted through a user's voice, a voice signal spoken by the user toward the electronic device may be converted into characters in the electronic device, and the converted characters may be transmitted to another electronic device (for example, a server) as a search term. Another electronic device (for example, the server) may transmit a result of retrieving based on the received search term to the electronic device (for example, the smartphone), and the electronic device may display the result of the retrieving for the user. The electronic device (for example, the smartphone or the server) may return contents which have nothing to do with or are less related to a context desired by the user as the result of the retrieving the information.

In addition, the user may control a plurality of electronic devices (for example, a TV, an audio player) through a voice signal input, but the electronic devices may be controlled without reflecting a user's intention fully. For example, a content (for example, music or a moving image) indicated by a voice input (for example, a demonstrative pronoun) may be executed through the plurality of electronic devices, but the user may wish the content to be executed through only one of the plurality of electronic devices. In this case, at least one of the plurality of electronic devices should know the user's intention, that is, should acquire information on a specific device to execute the corresponding content, through a voice input or other types of inputs, in order to perform a function corresponding to the user's intention.

### SUMMARY

Various example embodiments of the disclosure provide an electronic device which performs a function corresponding to a user's intention using another input of a user when processing a user's voice input.

According to an aspect of the present disclosure, a method in an electronic device is disclosed, including receiving a voice input and detecting a gesture associated with the voice input, selecting at least one content displayed on one or more displays functionally connected with the electronic device based on the detected gesture, determining a function corresponding to the voice input based on the selected at least one content, and executing by at least one processor the determined function.

According to an aspect of the present disclosure, an electronic device is disclosed, including at least one sensor configured to detect a gesture, and at least one processor coupled to a memory, configured to receive a voice input, detect, via the at least one sensor, a gesture associated with the received voice input, select at least one content displayed on one or more displays functionally connected with the electronic device based on the detected gesture, determine a function corresponding to the voice input based on the selected at least one content, and execute the determined function.

According to an aspect of the present disclosure, a non-transitory computer-readable recording medium in an electronic device is disclosed, the non-transitory computer-readable medium recording a program executable by a processor to: receive a voice input, detect, via at least one sensor a gesture associated with the voice input, select at least one content displayed on one or more displays functionally connected with the electronic device based on the gesture, and determine a function corresponding to the voice input based on the selected at least one content and executed the determined function.

### BRIEF DESCRIPTION OF THE DRAWINGS

For a more complete understanding of the present disclosure, reference is now made to the following description taken in conjunction with the accompanying drawings, in which like reference numerals represent like parts:

FIG. 1 illustrates a view showing an example of an environment in which an electronic device processes a user's input according to various example embodiments;

FIG. 2 illustrates a view showing an example of a network environment including an electronic device according to various example embodiments;

FIG. 3 illustrates a block diagram of an electronic device according to various example embodiments;

FIG. 4 illustrates a block diagram of a program module according to various example embodiments;

FIG. 5 illustrates a block diagram of an input processing module to process a user's input according to various example embodiments;

FIG. 6 illustrates a view showing a method for processing a user's input based on a content in an electronic device according to various example embodiments;

FIG. 7 illustrates a view showing a method for processing a user's input using an image in an electronic device according to various example embodiments;

FIG. 8 illustrates a view showing a method for processing a user's input based on a content in an electronic device according to various example embodiments;

FIG. 9A and FIG. 9B illustrate views showing a method for displaying a content in an electronic device and a process of displaying a process of processing a user's input according to various example embodiments;

FIG. 10 illustrates a flowchart showing a method for processing a user's input based on a content in an electronic device according to various example embodiments; and

FIG. 11 and FIG. 12 illustrate flowcharts showing methods for processing a user's input based on a content in an electronic device according to various example embodiments.

### DETAILED DESCRIPTION

Hereinafter, various embodiments of the present disclosure will be described with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the present disclosure. In addition, descriptions of well-known functions and implementations are omitted for clarity and conciseness.

The present disclosure may have various embodiments, and modifications and changes may be made therein. Therefore, the present disclosure will be described in detail with reference to particular embodiments shown in the accompanying drawings. However, it should be understood that the present disclosure is not limited to the particular embodiments, but includes all modifications/changes, equivalents, and/or alternatives falling within the present disclosure. In describing the drawings, similar reference numerals may be used to designate similar elements.

The terms “have”, “may have”, “include”, or “may include” used in the various embodiments of the present disclosure indicate the presence of disclosed corresponding functions, operations, elements, and the like, and do not limit additional one or more functions, operations, elements, and the like. In addition, it should be understood that the terms “include” or “have” used in the various embodiments of the present disclosure are to indicate the presence of features, numbers, steps, operations, elements, parts, or a combination thereof described in the specifications, and do not preclude the presence or addition of one or more other features, numbers, steps, operations, elements, parts, or a combination thereof.

The terms “A or B”, “at least one of A or/and B” or “one or more of A or/and B” used in the various embodiments of the present disclosure include any and all combinations of words enumerated with it. For example, “A or B”, “at least one of A and B” or “at least one of A or B” means (1) including at least one A, (2) including at least one B, or (3) including both at least one A and at least one B.

Although the term such as “first” and “second” used in various embodiments of the present disclosure may modify various elements of various embodiments, these terms do not limit the corresponding elements. For example, these terms do not limit an order and/or importance of the corresponding elements. These terms may be used for the purpose of distinguishing one element from another element. For example, a first user device and a second user device all indicate user devices and may indicate different user devices. For example, a first element may be named a second element without departing from the various embodiments of the present disclosure, and similarly, a second element may be named a first element.

It will be understood that when an element (e.g., first element) is “connected to” or “(operatively or communicatively) coupled with/to” to another element (e.g., second element), the element may be directly connected or coupled to another element, and there may be an intervening element (e.g., third element) between the element and another element. To the contrary, it will be understood that when an element (e.g., first element) is “directly connected” or “directly coupled” to another element (e.g., second element), there is no intervening element (e.g., third element) between the element and another element.

The expression “configured to (or set to)” used in various embodiments of the present disclosure may be replaced with “suitable for”, “having the capacity to”, “designed to”, “adapted to”, “made to”, or “capable of” according to a situation. The term “configured to (set to)” does not necessarily mean “specifically designed to” in a hardware level. Instead, the expression “apparatus configured to . . . ” may mean that the apparatus is “capable of . . . ” along with other devices or parts in a certain situation. For example, “a processor configured to (set to) perform A, B, and C” may be a dedicated processor, e.g., an embedded processor, for performing a corresponding operation, or a generic-purpose processor, e.g., a Central Processing Unit (CPU) or an application processor (AP), capable of performing a corresponding operation by executing one or more software programs stored in a memory device.

The terms as used herein are used merely to describe certain embodiments and are not intended to limit the present disclosure. As used herein, singular forms may include plural forms as well unless the context explicitly indicates otherwise. Further, all the terms used herein, including technical and scientific terms, should be interpreted to have the same meanings as commonly understood by those skilled in the art to which the present disclosure pertains, and should not be interpreted to have ideal or excessively formal meanings unless explicitly defined in various embodiments of the present disclosure.

The module or program module according to various embodiments of the present disclosure may further include at least one or more elements among the aforementioned elements, or may omit some of them, or may further include additional other elements. Operations performed by a module, programming module, or other elements according to various embodiments of the present disclosure may be executed in a sequential, parallel, repetitive, or heuristic manner. In addition, some of the operations may be executed in a different order or may be omitted, or other operations may be added.

An electronic device according to various embodiments of the present disclosure may be a device. For example, the electronic device according to various embodiments of the present disclosure may include at least one of: a smart phone; a tablet personal computer (PC); a mobile phone; a video phone; an e-book reader; a desktop PC; a laptop PC; a netbook computer; a workstation, a server, a personal digital assistant (PDA); a portable multimedia player (PMP); an MP3 player; a mobile medical device; a camera; or a wearable device (e.g., a head-mount-device (HMD), an electronic glasses, an electronic clothing, an electronic bracelet, an electronic necklace, an electronic appcessory, an electronic tattoo, a smart minor, or a smart watch).

In other embodiments, an electronic device may be a smart home appliance. For example, of such appliances may include at least one of: a television (TV); a digital video disk (DVD) player; an audio component; a refrigerator; an air conditioner; a vacuum cleaner; an oven; a microwave oven; a washing machine; an air cleaner; a set-top box; a home automation control panel; a security control panel; a TV box (e.g., Samsung HomeSync®, Apple TV®, or Google TV); a game console (e.g., Xbox® PlayStation®); an electronic dictionary; an electronic key; a camcorder; or an electronic frame.

In other embodiments, an electronic device may include at least one of: a medical equipment (e.g., a mobile medical device (e.g., a blood glucose monitoring device, a heart rate monitor, a blood pressure monitoring device or a temperature meter), a magnetic resonance angiography (MRA) machine, a magnetic resonance imaging (MRI) machine, a computed tomography (CT) scanner, or an ultrasound machine); a navigation device; a global positioning system (GPS) receiver; an event data recorder (EDR); a flight data recorder (FDR); an in-vehicle infotainment device; an electronic equipment for a ship (e.g., ship navigation equipment and/or a gyrocompass); an avionics equipment; a security equipment; a head unit for vehicle; an industrial or home robot; an automatic teller's machine (ATM) of a financial institution, point of sale (POS) device at a retail store, or an internet of things device (e.g., a Lightbulb, various sensors, an electronic meter, a gas meter, a sprinkler, a fire alarm, a thermostat, a streetlamp, a toaster, a sporting equipment, a hot-water tank, a heater, or a boiler and the like).

In certain embodiments, an electronic device may include at least one of: a piece of furniture or a building/structure; an electronic board; an electronic signature receiving device; a projector; or various measuring instruments (e.g., a water meter, an electricity meter, a gas meter, or a wave meter).

An electronic device according to various embodiments of the present disclosure may also include a combination of one or more of the above-mentioned devices.

Further, it will be apparent to those skilled in the art that an electronic device according to various embodiments of the present disclosure is not limited to the above-mentioned devices.

Herein, the term “user” may indicate a person who uses an electronic device or a device (e.g., an artificial intelligence electronic device) that uses the electronic device.

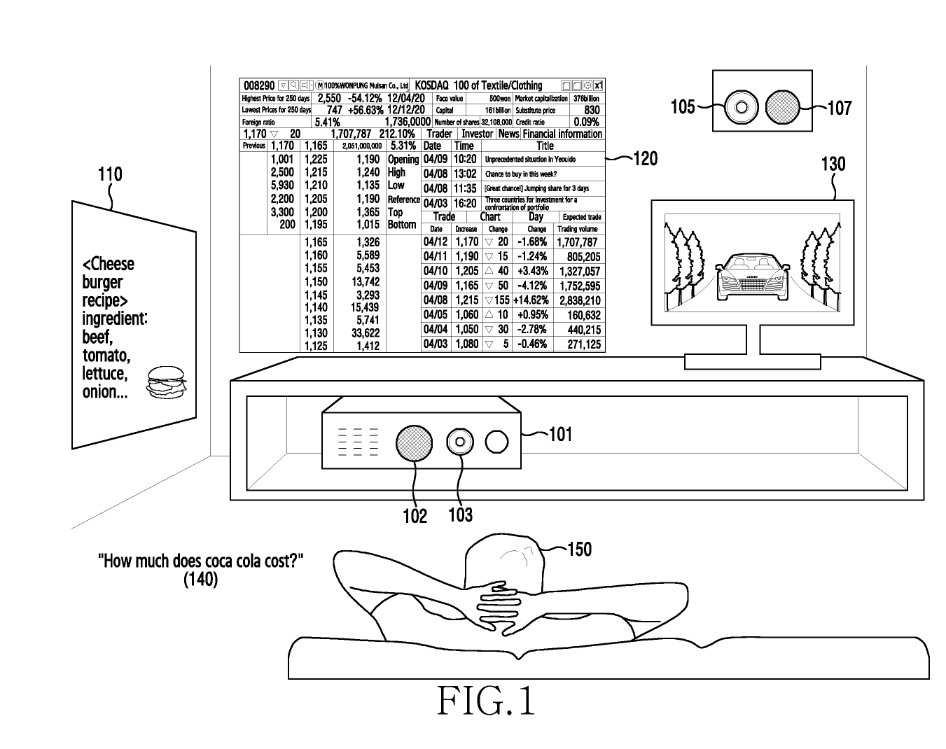

FIG. 1 illustrates a view showing an example of an environment in which an electronic device (for example, an electronic device 101) processes an input of a user 150. Referring to FIG. 1, the electronic device 101 may include an audio input module (for example, a microphone 102) or an image input module (for example, a camera 103). According to various example embodiments, the electronic device 101 may be functionally connected with one or more external devices (for example, a camera 105, a microphone 107, or displays 110, 120, and 130) to control the external devices. The electronic device 101 may be a smartphone which is provided with at least one display, for example.

According to various example embodiments, the electronic device 101 may receive an input of a voice signal which is spoken by the user 150, and determine a task or a parameter corresponding to the voice signal. For example, when the electronic device 101 receives a voice signal “How much does Coca Cola cost?” 140, which is spoken by the user 150, through the microphone 102 or 107 functionally connected (e.g., or communicatively coupled) with the electronic device 101, the electronic device 101 may convert the received voice signal into a set of characters. The set of characters may include a string of characters (or a character string). In response to the voice signal, the electronic device 101 may determine an information retrieving task corresponding to expressions/clauses/phrases “How much does” and “cost?,” which are parts of the set of characters, as a task to be performed by the electronic device 101. The electronic device 101 may determine the word “Coca Cola” from among the set of characters as a parameter of the task (for example, information to be retrieved).

According to various example embodiments, the electronic device 101 may select a tool for performing a task. For example, the tool for performing the information retrieving task may be a web browser. Hereinafter, a function may correspond to a parameter and/or a tool for performing a corresponding task, as well as the task. According to various example embodiments, the electronic device 101 may perform a function corresponding to a voice signal input using an external electronic device. For example, when the electronic device 101 performs the information retrieving task through the web browser, the electronic device 101 may transmit “Coca Cola” from among the set of characters to an external server. The external server may retrieve information based on the search term “Coca Cola,” and transmit the result of the retrieving the information to the electronic device 101. In addition, the electronic device 101 may display the result of the retrieving the information using an external display (for example, 110, 120, or 130).

According to various example embodiments, when one or more functions correspond to a voice signal input, the electronic device 101 may limit the range of the function corresponding to the voice signal input or reduce the number of functions corresponding to the voice signal input based on a content which is selected by the user. According to various example embodiments, the electronic device 101 may detect a user's gesture, and determine which of the contents displayed on the display is selected or indicated by the user. According to various example embodiments, the electronic device 101 may analyze an image which is photographed by the camera (for example, 103 or 105), and recognize a user's gesture. The electronic device 101 may recognize a user's gesture such as a location, a face, a head direction, gaze, or a hand motion from the image, and determine what the user is looking at or what the user is indicating.

For example, the electronic device 101 may display a cooking-related content through the display 110 and display a stock-related content through the display 120. The electronic device 101 may receive the voice signal “How much does Coca Cola cost?” 140 from the user 150, and simultaneously, may acquire an image related to the gesture of the user 150 through the camera (for example, 103, 105). When the electronic device 101 determines that the user uttered the voice while looking at the display 110 through the image, the electronic device 101 may limit a category of a meaning corresponding to the voice to a cooking category corresponding to the category of the content displayed on the display 110 that the user was looking at. When the electronic device 101 determines that the user uttered the voice while looking at the display 120 through the image, the electronic device 101 may limit the category of the meaning corresponding to the voice signal to a stock category corresponding to the category of the content displayed on the display 120 that the user was looking at. For example, when the category of the meaning of the voice signal is limited to the cooking category, the electronic device 101 may recognize the meaning of the voice signal of “Coca Cola” as “one bottle of Coca Cola.” In addition, when the category of the meaning of the voice signal is limited to the stock category, the electronic device 101 may recognize the meaning of the voice signal of “Coca Cola” as “Coca-Cola company.” For example, when the category of the meaning of the voice signal is limited to the cooking category, the electronic device 101 may determine an ingredient retail price search task as a task corresponding to the phrases “How much does” and “cost?” In addition, when the category of the meaning of the voice signal is limited to the stock category, the electronic device 101 may determine a stock quotation search task as a task corresponding to the phrases “How much does” and “cost?” As the task is determined differently, the tool may be an online market application or a stock trading application.

According to various example embodiments, the electronic device 101 may process a function corresponding to a voice input using the electronic device 101 or an external electronic device based on a selected content. For example, when the electronic device 101 performs the stock quotation search task corresponding to the voice input based on the stock-related content, the electronic device 101 may substitute the set of characters “Coca Cola” with the set of characters “Coca-Cola company” based on the gesture input, and transmit the set of characters to the external server, or may additionally transmit a command to exclude the set of characters “one bottle of Coca Cola.” The external server may search stock quotations using the set of characters “Coca-Cola company” as a search term, and transmit the result of the searching the stock quotations to the electronic device 101.

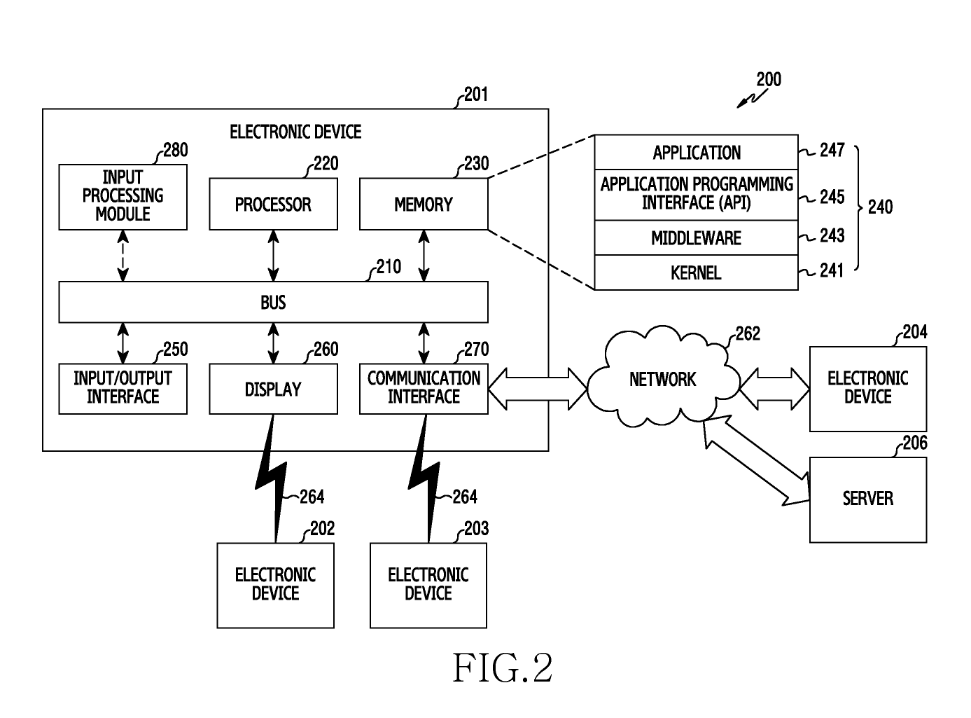

Referring to FIG. 2, an electronic device 201 in a network environment 200 according to various example embodiments will be explained. Referring to FIG. 2, an electronic device 201 may include a bus 210, a processor 220, a memory 230, an input/output interface 250, a display (e.g., touch screen) 260, a communication interface 270, and an input processing module 280. According to various embodiments of the present disclosure, at least one of the components of the electronic device 201 may be omitted, or other components may be additionally included in the electronic device 201. 20

The bus 210 may be a circuit that connects the processor 220, the memory 230, the input/output interface 250, the display 260, the communication interface 270, or the input processing module 280 and transmits communication (for example, control messages or/and data) between the above described components.

The processor 220 includes at least one central processing unit (CPU), application processor (AP) and communication processor (CP). For example, the processor 220 may carry out operations or data processing related to control and/or communication of at least one other component (for example, the memory 230, the input/output interface 250, the display 260, the communication interface 270, or the input processing module 280) of the electronic device 201. For example, the processor 220 may receive an instruction from the input processing module 280, decode the received instruction, and carry out operations or data processing according to the decoded instruction.

The memory 230 includes at least one of the other elements in the non-volatile memories. The memory 230 may store commands or data (e.g., a reference pattern or a reference touch area) associated with one or more other components of the electronic device 201. According to one embodiment, the memory 230 may store software and/or a program 240. For example, the program 240 may include a kernel 241, a middleware 243, an API (Application Programming Interface) 245, an application program 247, or the like. At least some of the kernel 241, the middleware 243, and the API 245 may be referred to as an OS (Operating System). According to various example embodiments, the application program 247 may be a web browser or a multimedia player, and the memory 230 may store data related to a web page or data related to a multimedia file. According to various example embodiments, the input processing module 280 may access the memory 230 and recognize data corresponding to an input.

The kernel 241 may control or manage system resources (e.g., the bus 210, the processor 220, or the memory 230) used for performing an operation or function implemented by the other programs (e.g., the middleware 243, the API 245, or the applications 247). Furthermore, the kernel 241 may provide an interface through which the middleware 243, the API 245, or the applications 247 may access the individual elements of the electronic device 201 to control or manage the system resources.

The middleware 243, for example, may function as an intermediary for allowing the API 245 or the applications 247 to communicate with the kernel 241 to exchange data.

In addition, the middleware 243 may process one or more task requests received from the applications 247 according to priorities thereof. For example, the middleware 243 may assign priorities for using the system resources (e.g., the bus 210, the processor 220, the memory 230, or the like) of the electronic device 201, to at least one of the applications 247. For example, the middleware 243 may perform scheduling or loading balancing on the one or more task requests by processing the one or more task requests according to the priorities assigned thereto.

The API 245 is an interface through which the applications 247 control functions provided from the kernel 241 or the middleware 243, and may include, for example, at least one interface or function (e.g., instruction) for file control, window control, image processing, or text control.

The input/output interface 250 may forward instructions or data input from a user through an input/output device (e.g., various sensors, such as an acceleration sensor or a gyro sensor, and/or a device such as a keyboard or a touch screen), to the processor 220, the memory 230, or the communication interface 270 through the bus 210. For example, the input/output interface 250 may provide the processor 220 with data on a user' touch entered on a touch screen. Furthermore, the input/output interface 250 may output instructions or data, received from, for example, the processor 220, the memory 230, or the communication interface 270 via the bus 210, through an output unit (e.g., a speaker or the display 260). 15

The display 260 may include, for example, a liquid crystal display (LCD), a light emitting diode (LED) display, an organic LED (OLED) display, a micro electro mechanical system (MEMS) display, an electronic paper display, and the like. The display 260, for example, may display various types of content (e.g., a text, images, videos, icons, symbols, and the like) for the user. The display 260 may include a touch screen and receive, for example, a touch, a gesture, proximity, a hovering input, and the like, using an electronic pen or the user's body part. According to an embodiment of the present disclosure, the display 160 may display a web page. For example, the display 260 may exist in the electronic device 201, and may be disposed on the front surface, side surface or rear surface of the electronic device 201. The display 260 may be hidden or revealed in a folding method, a sliding method, etc. In addition, the at least one display 260 may exist outside the electronic device 201 and may be functionally connected with the electronic device 201.

The communication interface 270, for example, may set communication between the electronic device 201 and an external device (e.g., the first external electronic device 202, the second external electronic device 203, the third external electronic device 204, or the server 206). For example, the communication interface 270 may be connected to a network 262 through wireless or wired communication to communicate with the external device (e.g., the third external electronic device 204 or the server 206). When the display 260 exists outside the electronic device 201, the display 260 may be functionally connected with the electronic device 201 using the communication interface 270.

The wireless communication 264 may include at least one of, for example, Wi-Fi, Bluetooth (BT), near field communication (NFC), a global positioning system (GPS), and cellular communication (e.g., LTE, LTE-A, CDMA, WCDMA, UMTS, WiBro, GSM, etc.). The wired communication may include at least one of, for example, a universal serial bus (USB), a high definition multimedia interface (HDMI), recommended standard 232 (RS-232), and a plain old telephone Service (POTS).

The network 262 may be a telecommunication network. The communication network may include at least one of a computer network, the Internet, the Internet of Things, and a telephone network.

The input processing module 280 may obtain at least one user input that includes at least one voice input or gesture input, via the external electronic device (for example: the first external electronic device 202, the second external electronic device 203, the third external electronic device 204, or the server 206), or at least one other component (for example: the input/output interface 250 or at least one sensor) of the electronic device 201, carry out at least one function according to the obtained user input. 25

According to various embodiments of the present disclosure, at least part of the input processing module 280 may be integrated with the processor 220. For example, the at least part of the input processing module 280 may be stored in the memory 230 in the form of software. For example, the at least part of the input processing module 280 30 may be distributed the processor 220 and the memory 230.

For example, at least one of the first external electronic device 202, the second external electronic device 203 or the third external electronic device 204 may be a device which is the same as or different from the electronic device 201. For example, the first external electronic device 202 or the second external electronic device 203 may be the display 260. For example, the first external electronic device 202 may be a wearable device. According to an embodiment of the present disclosure, the server 106 may include a group of one or more servers. According to various embodiments of the present disclosure, all or a part of operations performed in the electronic device 201 can be performed in the other electronic device or multiple electronic devices (e.g., the first external electronic device 202 or the second external electronic device 203 or the third external electronic device 204 or the server 206).

For example, a wearable device worn by the user may receive a user's voice signal and transmit the voice signal to the input processing module 280 of the electronic device 201. According to an example embodiment, when the electronic device 201 should perform a certain function or service automatically or according to a request, the electronic device 201 may request another device (for example, the electronic device 202, 204 or the server 206) to perform at least some function related to the function or the service, instead of performing the function or service by itself or additionally. Another electronic device (for example, the electronic device 202, 204 or the server 206) may perform the requested function or additional function, and transmit the result of the performing to the electronic device 201. The electronic device 201 may process the received result as it is or additionally, and provide the requested function or service. To achieve this, cloud computing, distributed computing, or client-server computing technology may be used. According to an example embodiment, the function may be a voice signal recognition-based information processing function, and the input processing module 280 may request the server 206 to process information through the network 262, and the server 206 may provide the result of performing corresponding to the request to the electronic device 201. According to an example embodiment, the electronic device 201 may control at least one of the first external electronic device 202 or the second external electronic device 203 to display a content through a display functionally connected with the at least one external electronic device. According to an example embodiment, when the first external electronic device 202 is a wearable device, the first external electronic device 202 may be implemented to perform at least some of the functions of the input/output interface 250. Another example embodiment may be implemented.

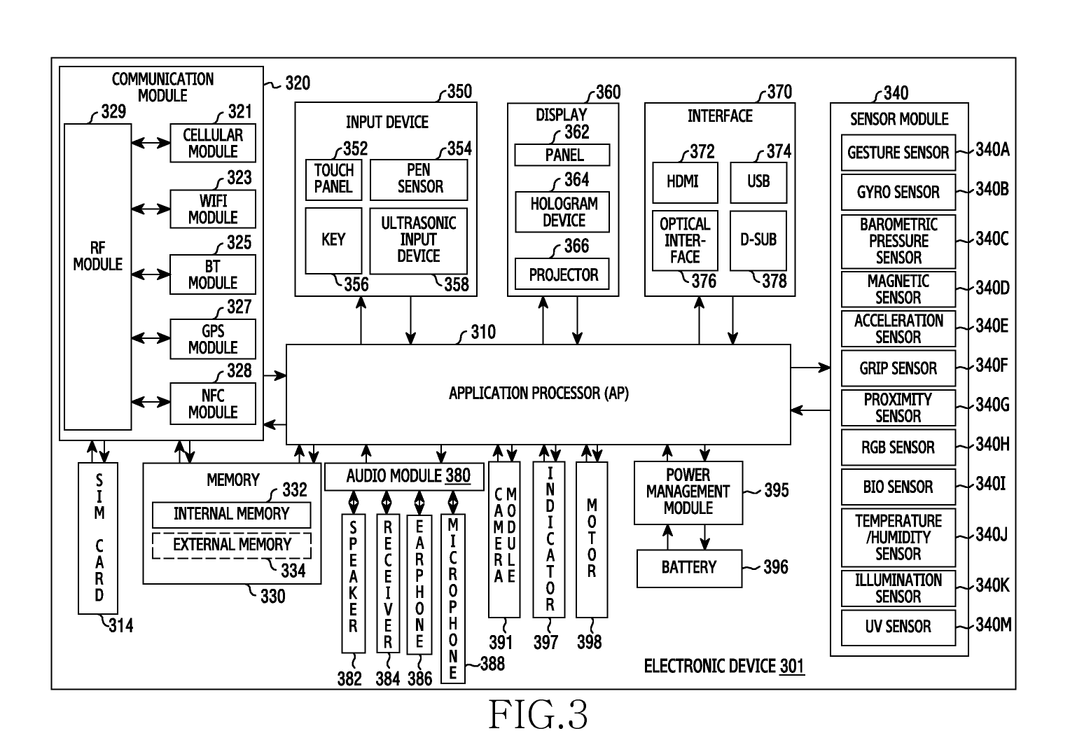

FIG. 3 illustrates a block diagram of an electronic device 301 according to various example embodiments. The electronic device 301 may include, for example, the entirety or a part of the electronic device 201 illustrated in FIG. 2, or may expand all or some elements of the electronic device 201. Referring to FIG. 3, the electronic device 301 may include an application processor (AP) 310, a communication module 320, a subscriber identification module (SIM) card 314, a memory 330, a sensor module 340, an input device 350, a display 360, an interface 370, an audio module 380, a camera module 391, a power management module 395, a battery 396, an indicator 397, or a motor 398.

The AP 310 may run an operating system or an application program to control a plurality of hardware or software elements connected to the AP 310, and may perform processing and operation of various data including multimedia data. The AP 310 may be, for example, implemented as a system on chip (SoC). According to an embodiment of the present disclosure, the AP 310 may further include a graphical processing unit (GPU) (not shown). The AP 310 may further includes at least one of other elements (ex: the cellular module 321) drown in FIG. 3. The AP 310 may load an instruction or data, which is received from a non-volatile memory connected to each or at least one of other elements, to a volatile memory and process the loaded instruction or data. In addition, the AP 310 may store in the non-volatile memory data, which is received from at least one of the other elements or is generated by at least one of the other elements.

The communication module 320 (e.g., the communication interface 270) may perform data transmission/reception in communication between the electronic device 301 (e.g., the electronic device 201) and other electronic devices connected through a network. According to an embodiment of the present disclosure, the communication module 320 may include a cellular module 321, a WiFi module 323, a BT module 325, a GPS module 327, an NFC module 328, and a radio frequency (RF) module 329.

The cellular module 321 may provide a voice telephony, a video telephony, a text service, an Internet service, and the like, through a telecommunication network (e.g., LTE, LTE-A, CDMA, WCDMA, UMTS, WiBro, GSM, and the like). In addition, the cellular module 321 may, for example, use a SIM (e.g., the SIM card 314) to perform electronic device distinction and authorization within the telecommunication network. According to an embodiment of the present disclosure, the cellular module 321 may perform at least some of functions that the AP 310 may provide. For example, the cellular module 321 may perform at least one part of a multimedia control function.

The WiFi module 323, the BT module 325, the GPS module 327 or the NFC module 328 each may include, for example, a processor for processing data transmitted/received through the corresponding module. According to an embodiment of the present disclosure, at least some (e.g., two or more) of the cellular module 321, the WiFi module 323, the BT module 325, the GPS module 327 or the NFC module 328 may be included within one IC or IC package.

The RF module 329 may perform transmission/reception of data, for example, transmission/reception of an RF signal. Though not illustrated, the RF module 329 may include, for example, a transceiver, a Power Amplifier Module (PAM), a frequency filter, a Low Noise Amplifier (LNA), an antenna and the like. According to an embodiment of the present disclosure, at least one of the cellular module 321, the WiFi module 323, the BT module 325, the GPS module 327 or the NFC module 328 may perform transmission/reception of an RF signal through a separate RF module.

The SIM card 314 may be a card including a SIM, and may be inserted into a slot provided in a specific position of the electronic device 301. The SIM card 314 may include unique identification information (e.g., an integrated circuit card ID (ICCID)) or subscriber information (e.g., an international mobile subscriber identity (IMSI)).

The memory 330 may include an internal memory 332 or an external memory 334. The internal memory 332 may include, for example, at least one of a volatile 30 memory (e.g., a dynamic random access memory (DRAM), a static RAM (SRAM) and a synchronous DRAM (SDRAM)) or a non-volatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a not and (NAND) flash memory, and a not or (NOR) flash memory).

According to an embodiment of the present disclosure, the internal memory 332 may be a solid state drive (SSD). The external memory 234 may further include a flash drive, for example, compact flash (CF), secure digital (SD), micro-SD, mini-SD, extreme digital (xD), a memory stick, and the like. The external memory 234 may be operatively connected with the electronic device 201 through various interfaces.

The sensor module 340 may measure a physical quantity or detect an activation state of the electronic device 301, and convert measured or detected information into an electric signal. The sensor module 340 may include, for example, at least one of a gesture sensor 340A, a gyro sensor 340B, an air pressure (or barometric) sensor 340C, a magnetic sensor 340D, an acceleration sensor 340E, a grip sensor 340F, a proximity sensor 340G a color sensor 340H (e.g., a red, green, blue “RGB” sensor), a bio-physical sensor 3401, a temperature/humidity sensor 340J, an illumination sensor 340K, a ultraviolet (UV) sensor 340M, and the like. Additionally or alternatively, the sensor module 340 may include, for example, an E-nose sensor (not shown), an electromyography (EMG) sensor (not shown), an electroencephalogram (EEG) sensor (not shown), an electrocardiogram (ECG) sensor (not shown), an infrared (IR) sensor (not shown), an iris sensor (not shown), a fingerprint sensor (not shown), and the like. The sensor module 340 may further include a control circuit for controlling at least one or more sensors belonging therein.

The input device 350 may include a touch panel 352, a (digital) pen sensor 354, a key 356, an ultrasonic input device 358, and the like. The touch panel 352 may, for example, detect a touch input in at least one of a capacitive overlay scheme, a pressure sensitive scheme, an infrared beam scheme, or an acoustic wave scheme. In addition, the touch panel 352 may further include a control circuit as well. In a case of the capacitive overlay scheme, physical contact or proximity detection is possible. The touch panel 352 may further include a tactile layer as well. In this case, the touch panel 352 may provide a tactile response to a user.

The (digital) pen sensor 354 may be implemented in the same or similar method to receiving a user's touch input or by using a separate sheet for detection. The key 356 may include, for example, a physical button, an optical key, or a keypad. The ultrasonic input device 358 is a device capable of identifying data by detecting a sound wave in the electronic device 301 through an input tool generating an ultrasonic signal, and enables wireless detection. According to an embodiment of the present disclosure, the electronic device 301 may also use the communication module 320 to receive a user input from an external device (e.g., a computer or a server) connected with this.

The display 360 (e.g., the display 260) may include a panel 362, a hologram device 364, or a projector 366. The panel 362 may be, for example, an LCD, an Active-Matrix Organic LED (AMOLED), and the like. The panel 362 may be, for example, implemented to be flexible, transparent, or wearable. The panel 362 may be implemented as one module along with the touch panel 352 as well. The hologram device 364 may use interference of light to show a three-dimensional image in the air.

The projector 366 may project light to a screen to display an image. The screen may be, for example, located inside or outside the electronic device 301. According to an embodiment of the present disclosure, the display 360 may further include a control circuit for controlling the panel 362, the hologram device 364, or the projector 366. 20

The interface 370 may include, for example, an HDMI 372, a USB 374, an optical interface 376, or a D-subminiature (D-sub) 378. Additionally or alternatively, the interface 370 may include, for example, a mobile high-definition link (MHL) interface, a SD card/multi media card (MMC) interface or an infrared data association (IrDA) standard interface.

The audio module 380 may convert a voice and an electric signal interactively. The audio module 380 may, for example, process sound information which is inputted or outputted through a speaker 382, a receiver 384, an earphone 386, the microphone 388, and the like. According to various example embodiments, the audio module 380 may receive an input of a user's voice signal using the microphone 388, and the application processor 310 may receive the voice signal from the microphone 388 and process a function corresponding to the voice signal.

The camera module 391 is a device able to take a still picture and a moving picture. According to an embodiment of the present disclosure, the camera module 391 may include one or more image sensors (e.g., a front sensor or a rear sensor), a lens (not shown), an image signal processor (ISP) (not shown), or a flash (not shown) (e.g., an LED or a xenon lamp). According to an example embodiment, the camera module 391 may photograph a user's motion as an image, and the application processor 310 may recognize a user from among visual objects in the image, analyze the user's motion, and recognize a gesture such as a user's location, a face, a head direction, gaze, and a hand motion.

The power management module 395 may manage electric power of the electronic device 301. Though not illustrated, the power management module 395 may include, for example, a power management integrated circuit (PMIC), a charger IC, a battery, a fuel gauge, and the like.

The PMIC may be, for example, mounted within an integrated circuit or an SoC semiconductor. A charging scheme may be divided into a wired charging scheme and a wireless charging scheme. The charger IC may charge the battery 396, and may prevent the inflow of overvoltage or overcurrent from an electric charger. According to an embodiment of the present disclosure, the charger IC may include a charger IC for at least one of the wired charging scheme or the wireless charging scheme. The wireless charging scheme may, for example, be a magnetic resonance scheme, a magnetic induction scheme, an electromagnetic wave scheme, and the like. A supplementary circuit for wireless charging, for example, a circuit, such as a coil loop, a resonance circuit, a rectifier, and the like, may be added.

The battery gauge may, for example, measure a level of the battery 396, a voltage during charging, a current or a temperature. The battery 396 may generate or store electricity, and use the stored or generated electricity to supply power to the electronic device 301. The battery 396 may include, for example, a rechargeable battery or a solar battery.

The indicator 397 may display a specific status of the electronic device 301 or one part (e.g., the AP 310) thereof, for example a booting state, a message state, a charging state, and the like. The motor 298 may convert an electric signal into a mechanical vibration. Though not illustrated, the electronic device 301 may include a processing device (e.g., a GPU) for mobile TV support. The processing device for mobile TV support may, for example, process media data according to the standards of digital multimedia broadcasting (DMB), digital video broadcasting (DVB), a media flow, and the like.

Each of the above-described elements of the electronic device according to various embodiments of the present disclosure may include one or more components, and the name of a corresponding element may vary according to the type of electronic device. The electronic device according to various embodiments of the present disclosure may include at least one of the above-described elements and may exclude some of the elements or further include other additional elements. Further, some of the elements of the electronic device according to various embodiments of the present disclosure may be coupled to form a single entity while performing the same functions as those of the corresponding elements before the coupling.

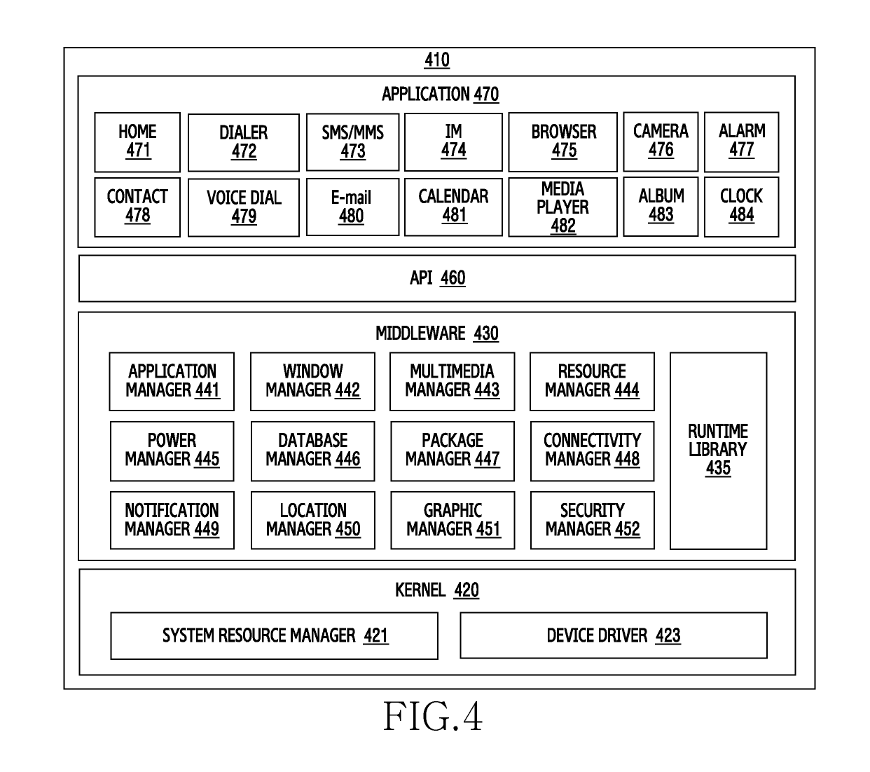

FIG. 4 illustrates a block diagram of a program module according to various example embodiments. Referring to FIG. 3, according to an embodiment of the present disclosure, a program module 410 (e.g., a program 240) may include an OS for controlling resources associated with an electronic apparatus (e.g., the electronic device 201) and/or various applications (e.g., an application program 247) running on the operating system. The OS may be, for example, Android, iOS, Windows, Symbian, Tizen, Bada, and the like.

The program module 410 may include a kernel 420, middleware 430, an API 460, and/or an application 470. At least a part of the program module 410 can be preloaded on the electronic device (e.g., electronic device 201) or downloaded from the server.

The kernel 420 (e.g., the kernel 241) may include, for example, a system resource manager 421 or a device driver 423. The system resource manager 421 may control, allocate, or collect the system resources. According to an example embodiment, the system resource manager 421 may include a process manager, a memory manager, a file system manager, etc. For example, the device driver 423 may include a display driver, a camera driver, a Bluetooth driver, a sharing memory driver, a USB driver, a keypad driver, a WiFi driver, an audio driver, or Inter-Process Communication (IPC) driver.

The middleware 430 may provide, for example, a function commonly utilized by the applications 470 in common or provide various functions to the applications 470 through the API 460 so that the applications 470 can efficiently use limited system resources within the electronic device. According to an example embodiment, the middleware 430 (for example, the middleware 243) may include at least one of a run time library 435, an application manager 441, a window manager 442, a multimedia manager 443, a resource manager 444, a power manager 445, a database manager 446, a package manager 447, a connectivity manager 448, a notification manager 449, a location manager 450, a graphic manager 451, or a security manager 452.

For example, the run time library 435 may include a library module which is used by a compiler to add a new function through a programming language while the application 470 is executed. The run time library 435 may perform a function on input and output management, memory management, or an arithmetic function.

For example, the application manager 441 may manage a life cycle of at least one of the applications 470. The window manager 442 may mange GUI resources which are used in the screen. The multimedia manager 443 may grasp a format utilized for reproducing various media files, and encode or decode the medial files using a codec corresponding to a corresponding format. The resource manager 444 may manage resources of at least one of the applications 470, such as a source code, a memory, or a storage space.

For example, the power manager 445 may operate with a Basic Input/Output System (BIOS), etc. to manage a battery or power, and provide power information, etc. utilized for the operation of the electronic device. The database manager 446 may generate, search, or change a database to be used in at least one of the applications 470. The package manager 447 may manage installing or updating of an application which is distributed in the form of a package file.

The connectivity manager 448 may manage wireless connection such as WiFi, Bluetooth, and the like. The notification manager 449 may display or notify an event such as a message arrived, an appointment, a notification of proximity in such a manner that the event does not hinder the user. The location manager 450 may manage location information of the electronic device. The graphic manager 451 may manage a graphic effect to be provided to the user or a relevant user interface. The security manager 452 may provide an overall security function utilized for system security or user authentication. According to an example embodiment, when the electronic device (for example, the electronic device 201) is equipped with a telephony function, the middleware 430 may further include a telephony manager to manage a speech or video telephony function of the electronic device.

The middleware 430 may include a middleware module to form a combination of the various functions of the above-described elements. The middleware 430 may provide a module which is customized according to a kind of OS to provide a distinct function. In addition, the middleware 430 may dynamically delete some of the existing elements or may add new elements.

The API 460 (for example, the API 245) is a set of API programming functions and may be provided as a different configuration according to an OS. For example, in the case of Android or iOS, a single API set may be provided for each platform. In the case of Tizen, two or more API sets may be provided for each platform.

The applications 470 (e.g., the application programs 247) may include, for example, one or more applications which can provide functions, such as a home function 471, a dialer 472, an SMS/MMS 473, an instant message (IM) 474, a browser 475, a camera 476, an alarm 477, contacts 478, a voice dialer 479, an email 480, a calendar 481, a media player 482, an album 483, a clock 484, a healthcare function (e.g., to measure exercise burnt calorie, or blood sugar), or an environment information (e.g., an atmospheric pressure, humidity, temperature information, and the like). According to an example embodiment, the application 470 may include an application for processing a function corresponding to a user's input (for example, a voice signal).

According to an embodiment of the present disclosure, the application 470 may include an application (hereinafter, for convenience of explanation, “Information Exchange application”) that supports the exchange of information between the electronic device (e.g., the electronic device 201) and the external electronic device. The application associated with exchanging information may include, for example, a notification relay application for notifying an external electronic device of certain information or a device management application for managing an external electronic device.

For example, a notification relay application may include a function of transferring the notification information generated by other applications (e.g., an SMS/MMS application, an e-mail application, a healthcare application, an environmental information application, and the like) of the electronic device to the external electronic device. Further, the notification relay application may receive notification information from, for example, the external electronic device and provide the received notification information to the user.

For example, the device management application may manage (e.g., install, delete, or update) at least one function (e.g., turning on/off the external electronic device itself (or some elements thereof) or adjusting the brightness (or resolution) of a display) of the external electronic device communicating with the electronic device, applications operating in the external electronic device, or services (e.g., a telephone call service or a message service) provided from the external electronic device.

According to an example embodiment, the application 470 may include an application (for example, a health care application, etc. of a mobile medical device) which is specified according to an attribute of an external electronic device (for example, the electronic device 202, 204). According to an example embodiment, the application 470 may include an application which is received from an external electronic device (for example, the server 206 or the electronic device 202, 204). According to an example embodiment, the application 470 may include a preloaded application or a third party application which may be downloaded from a server. The names of the elements of the program module 410 according to the illustrated example embodiment may be changed according to a kind of OS.

According to various embodiments of the present disclosure, at least a part of the program module 410 may be implemented in software, firmware, hardware, or a combination of two or more thereof. At least a part of the program module 410 can be implemented (e.g., executed), for example, by a processor (e.g., by an application program). At least some of the program module 410 may include, for example, a module, program, routine, sets of instructions, or process for performing one or more functions.

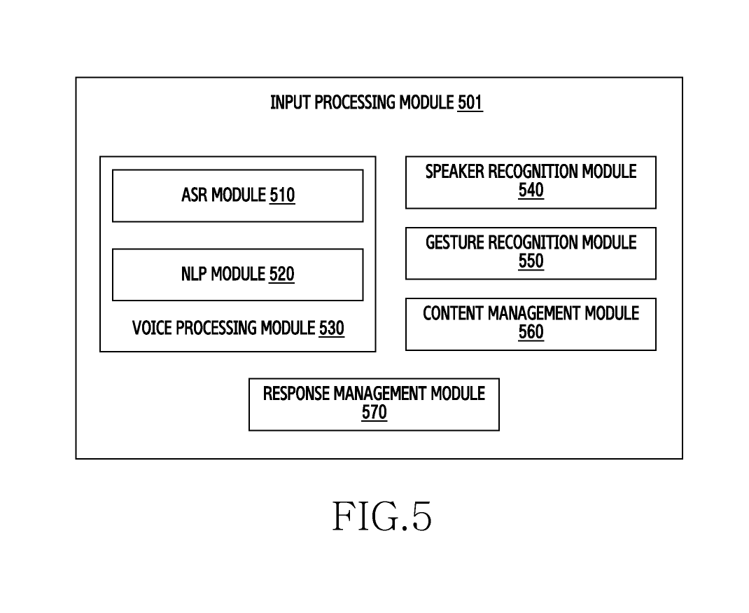

FIG. 5 illustrates a block diagram of an input processing module 501 for processing a user's input according to various example embodiments. The input processing module 501 of the electronic device may correspond to the input processing module 280 of the electronic device 201 shown in FIG. 2, for example. Referring to FIG. 5, the input processing module 501 may include Voice Processing Module 530, including an Automatic Speech Recognition (ASR) module 510, and a Natural Language Processing (NLP) module 520. The input processing module 501 may also include a speaker recognition module 540, a gesture recognition module 550, a content management module 560, or a response management module 570. According to various example embodiments, the ASR module 510, the NLP module 520, the speaker recognition module 540, the gesture recognition module 550, or the content management module 560 may be configured by a combination of one or more of software (for example, a programming module) or hardware (for example, an integrated circuit). In FIG. 5, the ASR module 510 and the NLP module 520 are illustrated as independent elements (modules), but various example embodiments are not limited to this. For example, the NLP module 520 may be implemented to process some of the functions corresponding to the ASR module 510, or the ASR module 510 may be implemented to process some of the functions corresponding to the NLP module 520. Another example embodiment may be implemented. According to various example embodiments, the ASR module 510 may convert a voice signal into a set of characters. For example, the ASR module 510 may analyze a voice signal in real time, convert the phonemes or syllables of the voice signal into characters corresponding to the phonemes or syllables, and form a set of characters by combining the converted characters. For example, the characters may be characters of various languages such as Korean, English, Japanese, Chinese, French, German, Spanish, Indian languages, etc. The set of characters may include at least one of a word, a phrase, a clause, an idiom, an expression, or a sentence.

According to various example embodiments, the ASR module 510 may convert the voice signal into the set of characters using one or two or more voice recognition techniques from among isolated word recognition, continuous speech recognition, or large vocabulary speech recognition. According to various example embodiments, the ASR module 510 may use various algorithms such as dynamic time warping, vector quantization, “hidden markov” model, support vector machine, neutral networks, etc.

during the process of using the voice recognition techniques. According to various example embodiments, in converting a user's voice signal into a set of characters, the ASR module 510 may determine characters corresponding to phonemes/syllables or a set of characters corresponding to the voice signal based on user's acoustic characteristics (for example, a frequency characteristic, a pitch, change in a pitch, an accented word, an intonation) in addition to the phonemes/syllables of the voice signal. For example, the ASR module 510 may convert a speaker corresponding to the voice signal (for example, a man, a woman, a child) to a set of characters by comparing the voice signal and various frequency characteristics. In addition, the ASR module 510 may determine whether the voice signal is an interrogative sentence or an imperative sentence by comparing the voice signal and various patterns of intonation. When the voice signal is determined to be the interrogative sentence, the ASR module 510 may add a question mark to the set of characters, and, when the voice signal is determined to be the imperative sentence, may add an exclamation mark to the set of characters.

According to various example embodiments, the ASR module 510 may receive a voice signal from an audio input module (for example, the microphone 102), and may convert the voice signal into a set of characters, for example, “How much does Coca Cola cost?” In addition, the ASR module 510 may transmit the set of characters to the NLP module 520.

According to various example embodiments, the NLP module 520 may convert a human natural language (for example, a voice signal form or a character form) into a form which can be understood and processed by a machine (for example, the electronic device 201), for example, digital data. For example, the NLP module 520 may determine a task to be performed by the input processing module 501, a parameter related to the task, or a tool for performing the task based on the digital data corresponding to the natural language. In addition, to the contrary, the NLP module 520 may convert digital data into information of a natural language form which can be understood by a human being, and provide the information of the natural language form to the user (visually or acoustically) or transmit the information to another electronic device. According to various example embodiments, the NLP module 520 may receive the set of characters which is converted by the ASR module 510. According to various example embodiments, the NLP module 520 may interpret a meaning of at least part of the set of characters using one or two or more natural language processing techniques from among part-of-speech tagging, syntactic analysis or parsing, and semantic analysis. According to an example embodiment, the NLP module 520 may acquire “show” which is one of a noun or a verb as a part of the set of characters. The NLP module 520 may limit the word “show” in the sentence “I want to see yesterday TV show” to the category of the noun through the part-of-speech tagging. For example, the NLP module 520 may recognize that “I” is a subject and “want to see yesterday TV show” is a predicate in the sentence through the syntactic analysis or parsing. For example, the NLP module 520 may recognize that “show” is a broadcasting term related to “TV”, and is a service (for example, a “TV program”) which is visually provided to “I” in the sentence through the semantic analysis. According to various example embodiments, the NLP module 520 may interpret the meaning of at least part of the set of characters using at least one of a rule-based approach or a statistical approach.

According to various example embodiments, the NLP module 520 may interpret the meaning of at least part of the set of characters using a method of processing only a character area of interest, such as keyword spotting, named entity recognition, etc. The NLP module 520 may determine which word of the set of characters is a keyword using the keyword spotting. The NLP module 520 may determine which category some word of the set of characters belongs to from among the categories of person names, place names, organization names, time, quantity, or call using the named entity recognition. For example, the NLP module 520 may generate “[Jim]_{Person} bought 300 shares of [Acme Corp.]_{Organization} in [2006]_{time.}” from “Jim bought 300 shares of Acme Corp. in 2006.” using the named entity recognition, and process each word based on the category corresponding to each word.

According to various example embodiments, the NLP module 520 may acquire task information including one or more tasks corresponding to the set of characters from a memory of the electronic device, and search a task corresponding to the meaning of the set of characters based on the acquired task information. For example, the NLP module 520 may acquire task information including “displaying photo,” “presenting multimedia,” and “showing broadcast” as a plurality of tasks corresponding to the set of characters “want to see.”

According to various example embodiments, the NLP module 520 may determine a task having high relevance to some word of the set of characters as a task corresponding to the set of characters. For example, the NLP module 520 may determine, from among the plurality of tasks “displaying photo,” “presenting multimedia,” and “showing broadcast”, the task “showing broadcast” that has highest relevance to the word “TV” included in the set of characters “I want to see yesterday TV show.” According to various example embodiments, the NLP module 520 may display a task which has highest relevance from among the plurality of tasks for the user. In addition, the NLP module 520 may list the plurality of task in order of relevance and display the tasks. For example, a table that includes at least one particular word corresponding to certain function (or task) may be pre-stored. For example, the NLP module 520 may determine a function corresponding to the at least one particular word.

According to various example embodiments, when the meaning of the set of characters is determined, the NLP module 520 may determine a parameter (for example, a name of an object to be processed, a form of an object to be processed, and the number of objects to be processed) corresponding to the meaning based on the task. For example, when the task is “showing broadcast,” a parameter corresponding the set of characters “yesterday TV show” may be “a list of TV program names viewed yesterday,” “video streaming,”, “1”, etc.

According to various example embodiments, the NLP module 520 may determine a task or a parameter corresponding to a user's voice signal or a set of characters based on a content selected by the user or user's context information. For example, when one or more tasks or parameters correspond to the meaning of the voice signal or the set of characters, the NLP module 520 may limit the meaning of the voice signal or the set of characters or may limit the scope of the parameter corresponding to the meaning of the set of characters using a content selected by the user. In addition, the NLP module 520 may limit the meaning of the set of characters or the scope of the task or the parameter corresponding to the meaning of the set of characters using context information (for example, information on an application in use, user location information, user environment information, available peripheral device information, a past voice signal, or a content selected in the past, etc.).

When a cooking-related content is displayed on a first display functionally connected with the electronic device, and a stock-related content is displayed on a second display functionally connected with the electronic device, the electronic device may recognize that the user spoke the sentence “How much does Coca Cola cost?” while looking at the second display of the first and the second displays through the ASR module 510. When there exist a plurality of parameters such as “one bottle of Coca Cola” or “Coca-Cola Company” as parameters corresponding to the word “Coca Cola,” which is a part of the sentence spoken by the user, the NLP module 520 may select the parameter “Coca-Cola Company” corresponding to the stock-related content displayed on the second display that the user was looking at from among the plurality of parameters.

According to various example embodiments, when one or more tasks or parameters correspond to the voice signal or the set of characters, the NLP module 520 may limit the scope of the task or parameter corresponding to the voice signal or the set of characters, based on a character extracted from at least part of the content or “meaning relation information” (for example, ontology or relation graph) related to at least part of the content. When the content displayed on the display functionally connected with the electronic device is a coworker communication room window for example, the NLP module 520 may acquire meaning relation information which includes a messenger application to be executed in the coworker communication room window as superordinate relation information of the coworker communication room window, and communication member information, which is user information used in the coworker communication room window, as subordinate relation information. When the “coworker communication room” window is displayed on a third display functionally connected with the electronic device, and a “received mails” window is displayed on a fourth display functionally connected with the electronic device, the electronic device may recognize that the user spoken the sentence “Share my schedule to Kevin!” while looking at the third display of the third and fourth displays through the ASR module 510. When there exists a plurality of tasks such as “sending messenger” or “sending email” as tasks corresponding to the word “share,” which is a part of the sentence spoken by the user, the NLP module 520 may select the task “sending messenger” based on the messenger application which is the superordinate relation information of the “coworker communication room.” When the NLP module 520 determines the task “sending messenger,” and there exist a plurality of parameters such as a messenger address or an email address as a receiver parameter corresponding to the word “Kevin,” which is a part of the sentence spoken by the user, the NLP module 520 may select the messenger address of a member called “Kevin” based on the messenger application which is the subordinate relation information of the “coworker communication room.”

According to various example embodiments, the entirety or part of the ASR module 510 or the NLP module 520 may be executed in another or a plurality of other electronic devices (for example, the electronic device 202, 204 or the server 206 of FIG. 2). According to an example embodiment, when the electronic device should perform at least one function of the ASR module 510 or the NLP module 520 automatically or according to a request, the electronic device may request another device (for example, the electronic device 202, 204 or the server 206) to perform at least some relevant function instead of performing the function by itself, or additionally. Another device (for example, the electronic device 202, 204 or the server 206) may execute the requested function or additional function, and transmit the result of the executing to the electronic device. The electronic device may process the received result as it is or additionally, and provide at least one function of the ASR module 510 or the NLP module 520.

According to various example embodiments, the electronic device (for example, 201 of FIG. 2) may transmit a predetermined query to the server (for example, 206 of FIG. 2), and acquire a result of searching based on the query from the server, thereby performing a search task for retrieving information. When the category of the corresponding query is limited to stock quotations by a user's voice or gesture in determining the query, the electronic device may substitute the set of characters, for example, “Coca Cola,” with the set of characters “Coca-Cola Company,” and transmit the set of characters to the server. The server retrieves information based on the search term “Coca-Cola company” and transmits the result of the retrieving the information to the electronic device. In addition, when the category of the corresponding query is limited the other items except for a cooking ingredient by a user's voice or gesture in determining the query, and an information retrieving task is performed, the electronic device transmits “Coca Cola” and additionally transmit a command to exclude “one bottle of Coca Cola,” and thus the server retrieves information based on the search term “Coca Cola,” excluding “one bottle of Coca Cola.”

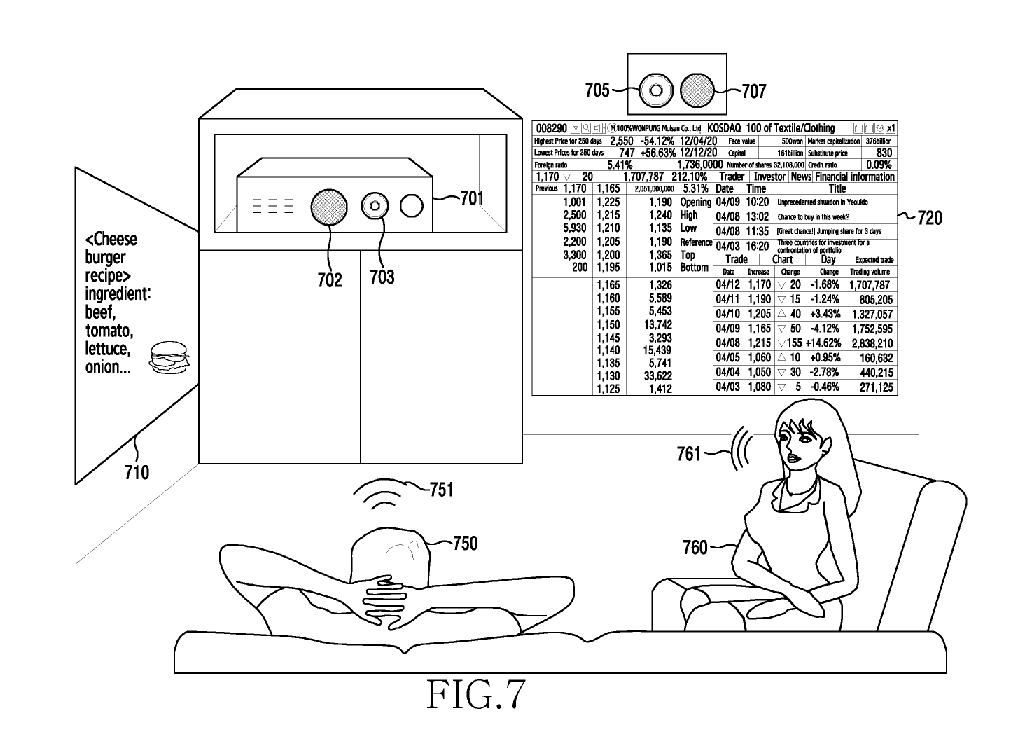

According to various example embodiments, the speaker recognition module 540 may distinguish at least one speaker from a plurality of speakers, and recognize as a speaker of a voice signal. For example, the speaker recognition module 540 may determine that voice signals of a plurality of speakers are mixed from a microphone (for example, the microphone 388) functionally connected with the electronic device, and select a voice signal which includes a certain voice signal pattern. The speaker recognition module 540 may compare motions of a plurality of visual objects photographed by a camera (for example, the camera module 391) functionally connected with the electronic device, and the voice signal including the certain voice signal pattern, and may recognize one of the plurality of visual objects as a speaker of the voice signal. Additional information on the speaker recognition module 540 will be provided in FIG. 7.

According to various example embodiments, the gesture recognition module 550 may acquire a still image or a moving image of a user (a user's motion) using at least one camera (for example, the camera module 391 of FIG. 3) functionally connected with the electronic device. According to various example embodiments, the gesture recognition module 550 may recognize user's presence/absence, location, gaze, head direction, hand motion, etc. using at least one sensor (for example, a camera, an image sensor, an infrared sensor) functionally connected with the electronic device, or an indoor positioning system. According to various example embodiments, the gesture recognition module 550 may include at least one of a face recognition unit (not shown), a face direction recognition unit (not shown), and a gaze direction sensing unit (not shown), for example. According to various example embodiments, the face recognition unit may extract a face characteristic from a photographed user face image, compare the face characteristic with at least one face characteristic data pre-stored in the memory (for example, 330 of FIG. 3), and recognize the face by detecting an object having similarity greater than or equal to a reference value. According to various example embodiments, the face direction recognition unit may determine a user's face location and a user's gaze direction using the angle and location of the detected face from among the top, bottom, left and right directions of the inputted image (for example, 0 degree, 90 degrees, 180 degrees, 270 degrees). According to various example embodiments, the gaze direction sensing unit may detect an image of an eye area of the user in the inputted image, compare the image of the eye area with eye area data related to various gazes, which is pre-stored in the memory (for example, 330 of FIG. 3), and detect which area of the display screen the user's gaze is fixed on.

According to various example embodiments, a display corresponding to a user's gaze from among the plurality of displays functionally connected with the electronic device may be determined based on an electronic device name (for example, a serial number of a display device) corresponding to location information (for example, coordinates) used in the indoor positioning system. According to various example embodiments, an area corresponding to the user's gaze from among a plurality of areas forming a display screen may be determined based on at least one pixel coordinate.

According to various example embodiments, the gesture recognition module 550 may analyze a photographed user image, and generate gesture information by considering which display the user is looking at, which area of a content the user is looking at, or what action the user is making using at least part of user's body. For example, the gesture recognition module 550 may transmit the generated gesture information to at least one of the other elements, the ASR module 510, the NLP module 520, the content management module 560, or the response management module 570.

According various example embodiments, the content management module 560 may process or manage information on at least part of a content which is displayed on a display functionally connected with the electronic device. According to various example embodiments, the content management module 560 may receive user's gesture information from the gesture recognition module 550, and may identify an electronic device name or display pixel coordinates from the gesture information. According to various example embodiments, the content management module 560 may identify at least part of a content corresponding to the electronic device name or the display pixel coordinates. For example, when the gesture recognition module 550 recognizes that the user is gazing at the second display of the first and second displays, the content management module 560 may receive the electronic device name of the second display that the user's head direction indicates from the gesture recognition module 550, and recognize that the content (category of the content) displayed on the second display is a stock-related content based on the received electronic device name. In addition, when the user gazes at the left upper area of the second display, the gesture recognition module 550 may identify an object (for example, a window or a menu name) corresponding to at least one pixel coordinate belonging to the left upper area that the user gazes at.

According to various example embodiments, the content management module 560 may generate information on the content that the user gazes at in various formats. For example, when the content that the user gazes at is an image content, the content management module 560 may extract characters corresponding to the image using Optical Character Recognition (OCR) or image recognition. In addition, when it is determined that there is “meaning relation information” (ontology or relation graph) as relevant information of the content that the user gazes at, the content management module 560 may identify the “meaning relation information” in the format of Resource Description Framework (RDF) or Web Ontology Framework (OWL). According to various example embodiments, the content management module 560 may transmit information on the content which is selected by the user's gesture to the NLP module 520.

According to various example embodiments, the response management module 570 may receive a task or a parameter from the NLP module 520, and determine which tool the electronic device 201 will execute based on the task or the parameter. According to various example embodiments, the tool may be an application or an Application Programming Interface (API). According to various example embodiments, the executing the tool may include all operations in a computing environment, such as executing or finishing an application, performing a function in an application, reducing, magnifying, or moving a window in an application, executing an API, etc.

According to various example embodiments, the response management module 570 may select the tool additionally based on user's context information, for example, at least one of an application that the user is using or previously used, user's location information, user's environment information, or an available peripheral device. According to various example embodiments, when the response management module 570 receives the task “sending messenger” and the parameter “Kevin” as at least part of the function corresponding to the set of characters, the response management module 570 may select a messenger application tool which opens a communication room with “Kevin” from among various messenger applications. According to various example embodiments, when the response management module 570 receives the task “searching stock quotations” and the parameter “Coca-Cola Company,” the response management module 570 may select a web browser tool having history which has been used in trading stocks from among various web browser tools. According to various example embodiments, when the response management module 570 receives the task “listening to music” as at least part of the function corresponding to the set of characters, the response management module 570 may execute an API for activating a function of a closest speaker to the location of the user.

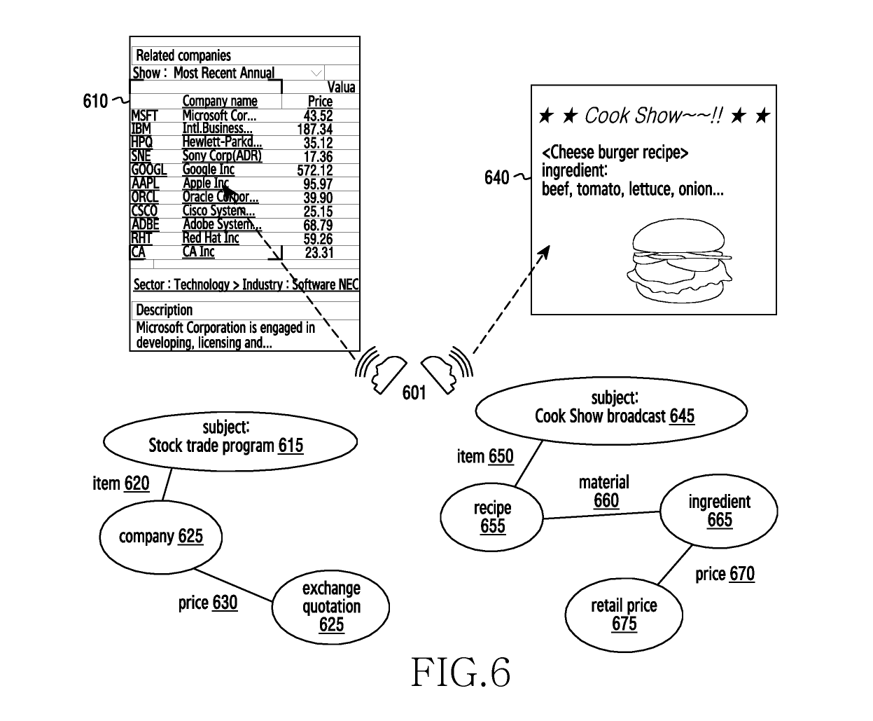

FIG. 6 illustrates a view showing a method for processing a user's input based on a content in an electronic device according to various example embodiments. For example, the electronic device (for example, 101 of FIG. 1) may include the NLP module 520, the gesture recognition module 550, and the content management module 560 shown in FIG. 5. The content management module 560 of the electronic device may transmit information related to at least part of a content which is selected by a user's gesture to the NLP module 520 in various formats. The information in various formats related to the content may be formed based on characters, and hereinafter, will be explained as an additional set of characters.

According to various example embodiments, at least one of a first content 610 or a second content 640 may be an image-based content (JPG PNG). According to various example embodiments, the content management module (for example, 560 of FIG. 5) may recognize characters written on the image using OCR or image recognition, and extract an additional set of characters from the image of the content 610 or 640. In addition, the content management module may capture the image in the content and transmit the image to the external server 206, and may receive an additional set of characters related to the image.

According to various example embodiments, at least one of the first content 610 or the second content 640 may be a content which is generated based on a web document (for example, HyperText Markup Language (HTML), HTMLS). According to various example embodiments, the content management module (for example, 560 of FIG. 5) may extract information related to at least part of the content (for example, an additional set of characters, “meaning relation information” (RDF, OWL)) using a web document analysis module (not shown). When the content is a web document, the content management module may give weight to sentences existing in a body based on metadata (for example, a tag) using the web document analysis module (not shown). The content management module may extract the additional set of characters such as an abstract or a subject using the sentences given weight. In addition, the content management module may receive “meaning relation information” (ontology or relation graph) related to the content from an external server as an additional set of characters, and analyze the web document in the content and extract “ontology or relation graph.”

According to various example embodiments, the “ontology or relation graph” may be expressed by the simplest format, Resource Description Framework (RDF), and may express a concept in a triple format of <subject, predicate, object>. For example, when information “bananas are yellow” that people think is expressed in a triple format (hereinafter, triple) which a machine can understand, the information may be expressed as <S: banana, P: color, O: yellow>. A computer interprets the triple expressed in this way, and may interpret and process a concept that the concept of “S: banana” has “O: color” of “P: yellow.” According to various example embodiments, the “meaning relation information” may be expressed in a format of <class, relation, instance, property>, and may be expressed in various formats.

According to various example embodiments, the content management module (for example, 560 of FIG. 5) may remove unnecessary words from the first content 610 in the web document format using metadata, and extract a subject “stock” using sentences existing in the body as an additional set of characters. In addition, the content management module may acquire “meaning relation information” as an additional set of characters related to the first content 610, and the “meaning relation information” may be expressed in the format of <subject 615, item 620, company 625> or <company 625, price 630, exchange quotation 635>. The objects of the first content 610 may be related to the “meaning relation information” indicating that “stock (subject) has an item called a company” or that “company has a price called exchange quotation.”

According to various example embodiments, when the gesture recognition module (for example, 550 of FIG. 5) recognizes that the user spoke the sentence “How much does Coca Cola cost?” while looking at the content 610, for example, the content management module (for example, 560 of FIG. 5) may transmit the subject “stock” extracted from the content 610 to the NLP module (for example, 520 of FIG. 5) as an additional set of characters. The NLP module 520 may limit the meaning of the set of characters “Coca Cola” to “Coca Cola Company” based on the subject “stock.”

According to various example embodiments, when the gesture recognition module (for example, 550 of FIG. 5) recognizes that the user looked at the content 610, the content management module (for example, 560 of FIG. 5) may transmit the “meaning relation information” 615, 620, 625, 630, 635 of the content 610 to the NLP module (for example, 520 of FIG. 5) as an additional set of characters. The NLP module may match the meaning of the set of characters “how much . . . cost” with the meaning of “price.” The NLP module may determine whether the “price” exists as a concept (element or class) in the “meaning relation information” based on the “meaning relation information,” and may find that the concept related to “price” is “company” 625 and “exchange quotation” 635. According to various example embodiments, the NLP module may give weight to the meaning of “Coca-Cola Company” from among various meanings corresponding to the set of characters “Coca Cola” based on the concept of “Company” 625 from among the additional set of characters of the “meaning relation information.”

According to various example embodiments, when the gesture recognition module (for example, 550 of FIG. 5) recognizes that the user uttered a voice while looking at the content 640, for example, the content management module 560 may transmit a subject “cooking” to the NLP module 520 as an additional set of characters. The NLP module 520 may limit the meaning of the set of characters “Coca Cola” to “one bottle of Coca Cola” based on the subject “cooking.”

According to various example embodiments, when the gesture recognition module (for example, 550 of FIG. 5) recognizes that the user looked at the content 640, for example, the content management module (for example, 560 of FIG. 5) may transmit “meaning relation information” 645, 650, 655, 660, 665, 670, 675 of the content 640 to the NLP module (for example, 520 of FIG. 5). The NLP module may match the meaning of the set of characters “How much . . . cost” with the meaning of “Price.” The NLP module may determine whether the “Price” exists as a concept (element or class) in the “meaning relation information,” and may find that the concept related to the concept “price” is “ingredient” 665, and “retail price” 675. According to various example embodiments, the NLP module may give weight to the meaning of “one bottle of Coca Cola” from among various meanings corresponding to the set of characters “Coca Cola” based on the “ingredient” from among the additional set of characters.” According to various example embodiments, the NLP module may determine the task or the parameter corresponding to the voice signal using at least part of the content.

FIG. 7 illustrates a view showing a method for processing a user's input using an image in an electronic device (for example, 701) according to various example embodiments. According to various example embodiments, the electronic device 701 may include a speaker recognition module (for example, 540 of FIG. 5) and a gesture recognition module (for example, 550 of FIG. 5). The speaker recognition module may receive an input of a voice signal using a microphone (for example, 702, 707) functionally connected with the electronic device, and may receive an input of an image signal (a still image or a moving image) using a camera (for example, 703, 705) functionally connected with the electronic device. The speaker recognition module may identify a speaker (or a user) corresponding to the received voice signal using the received image signal, for example.

The speaker recognition module (for example, 540 of FIG. 5; speakers referring to speaking users) may determine whether there are a plurality of speakers or not based on the received image signal. When it is determined that there are the plurality of speakers (for example, 750, 760), the received voice signal may include voice signals of the plurality of speakers which are mixed. The speaker recognition module may determine which of the voice signals of the plurality of speakers will be processed.

According to various example embodiments, the speaker recognition module may set a certain voice signal pattern (for example, “hi, galaxy”) as a trigger (e.g., a “voice trigger”) for processing voice signals, and may identify a voice signal that includes the voice trigger from among the voice signals of the plurality of speakers (for example, 750, 760). The speaker recognition module may determine the voice signal including the voice trigger as a “voice input corresponding to a function to be performed in the electronic device 701.”

The speaker recognition module (for example, 540 of FIG. 5) may identify at least one visual object corresponding to the voice signal including the voice trigger based on the image signal, for example. The visual object may include a person or a thing. The visual object may be an object which may be a source of a voice signal from among objects in the image, for example, an object which is recognized as a person or an animal. When a plurality of visual objects are identified, the speaker recognition module may calculate a degree of synchronization between each of the plurality of visual objects and the voice signal including the voice trigger using synchronization information of the image signal and the voice signal. In addition, the speaker recognition module may compare the voice signal including the voice trigger and mouth shapes of the plurality of visual objects (for example, 750, 760) at time of each of the image signals, and may identify a visual object which has a high degree of synchronization to the voice signal including the voice trigger from among the plurality of visual objects. For example, the speaker recognition module may determine a visual object having a high degree of synchronization as a speaker (for example, 760) (or user) who spoke the voice trigger 761 from among the plurality of visual objects.

According to various example embodiments, based on a pre-registered gesture trigger, the speaker recognition module (for example, 540 of FIG. 5) may identify a voice signal corresponding to the gesture trigger from among the voice signals of a plurality of speakers. For example, the speaker recognition module may set a certain motion pattern (for example, a hand motion) as a gesture trigger, and, when the voice signals of the plurality of speakers are inputted, may determine whether the gesture trigger occurs or not based on the image signal, and identify a visual object corresponding to the gesture trigger. When the gesture trigger occurs, the speaker recognition module may determine a visual object corresponding to the gesture trigger as a voice signal speaker (for example, 760) (or user). The speaker recognition module 540 may determine a voice signal having a high degree of synchronization to the visual object which made the gesture trigger as a “voice input corresponding to a function to be performed in the electronic device 701.”

According to various example embodiments, based on a touch trigger on the display, the speaker recognition module (for example, 540 of FIG. 5) may identify a voice signal corresponding to the touch trigger from among the voice signals of the plurality of speakers. For example, the speaker recognition module (for example, 540 of FIG. 5) may set a signal (event) indicating that the user (for example, 750) touches the display as a touch trigger, and may determine whether the touch trigger occurs or not while the voice signal or image signal is inputted. When the touch trigger occurs, the speaker recognition module (for example, 540 of FIG. 5) may analyze the plurality of visual objects (for example, 750 and 760) in the image signal, and determine a visual object corresponding to the touch trigger as a voice signal speaker (for example, 760) (or user). The speaker recognition module 540 may determine a voice signal having a high degree of synchronization to the visual object corresponding to the touch trigger as a “voice input corresponding to a function to be performed in the electronic device 701.”

According to various example embodiments, the speaker recognition module (for example, 540 of FIG. 5) may pre-register an external electronic device in a wearable device form (for example, 202 of FIG. 2) as a user device. The electronic device 701 may be connected with the external wearable device (202 of FIG. 2) in short-distance communication or long-distance communication, and exchange voice signals or data therewith. When the electronic device 701 is connected with the external wearable device, the speaker recognition module may receive, from the external wearable device, a user's voice signal sensed through the wearable device or location information of the wearable device. The speaker recognition module may identify a motion of a visual object corresponding to the location information of the wearable device, and identify a speaker of the voice signal.

According to various example embodiments, the speaker recognition module (for example, 540 of FIG. 5) may recognize locations of the speakers (for example, 750, 760) using at least one sensor (for example, a camera, an image sensor, an infrared sensor) or an indoor positioning system. For example, the speaker recognition module may recognize that the first speaker 750 is located adjacent to the front surface of the electronic device, and the second speaker 760 is located adjust to the left corner of the electronic device, and may express the locations of the speakers by location information (for example, a vector, coordinates, etc.) used in the indoor positioning system. According to various example embodiments, the speaker recognition module may generate multi-microphone processing information for controlling a plurality of microphones for sensing voice signals based on location information of a voice signal speaker (user). According to various example embodiments, the plurality of microphones (for example, 702, 707) functionally connected with the electronic device 701 may change their directions toward the voice signal speaker (such as a user/speaker 760) or activate the microphone which is installed toward the user from among the plurality of microphones, based on the multi-microphone processing information.

According to various example embodiments, when the gesture recognition module (for example, 550 of FIG. 5) recognizes that the user (for example, 760) executes a gesture (for example, a gaze, a head direction, or a hand motion) while speaking a voice signal (for example, 761), the gesture recognition module may generate gesture information using the gesture which was made within a predetermined time range from the time at which a voice signal was generated. For example, the gesture recognition module may be set to recognize a gesture which is made within 10 seconds from the time at which a voice signal is received as a gesture input. For example, when it is recognized that the user who is the second speaker 760 gazed at the second display 720 at 6:34:45 p.m., spoke “When does this rerun?” at 6:35:00 p.m., and then pointed at the first display 710 with user's finger at 6:35:05 p.m., the gesture recognition module may transmit an electronic device name (for example, a serial number of a display device) of the first display 710 to the content management module based on the gesture of “pointing at the first display 710 with user's finger,” which was made at 6:35:05 p.m. within 10 seconds from time 6:35:00 p.m. at which the voice signal “this” was generated. According to various example embodiments, the time range may be set by various time intervals. According to various example embodiments, the gesture recognition module 550 may disregard gestures which are made beyond the predetermined time range. For example, a gesture which was made at 6:35:50 may not be recognized as the user's gesture input.

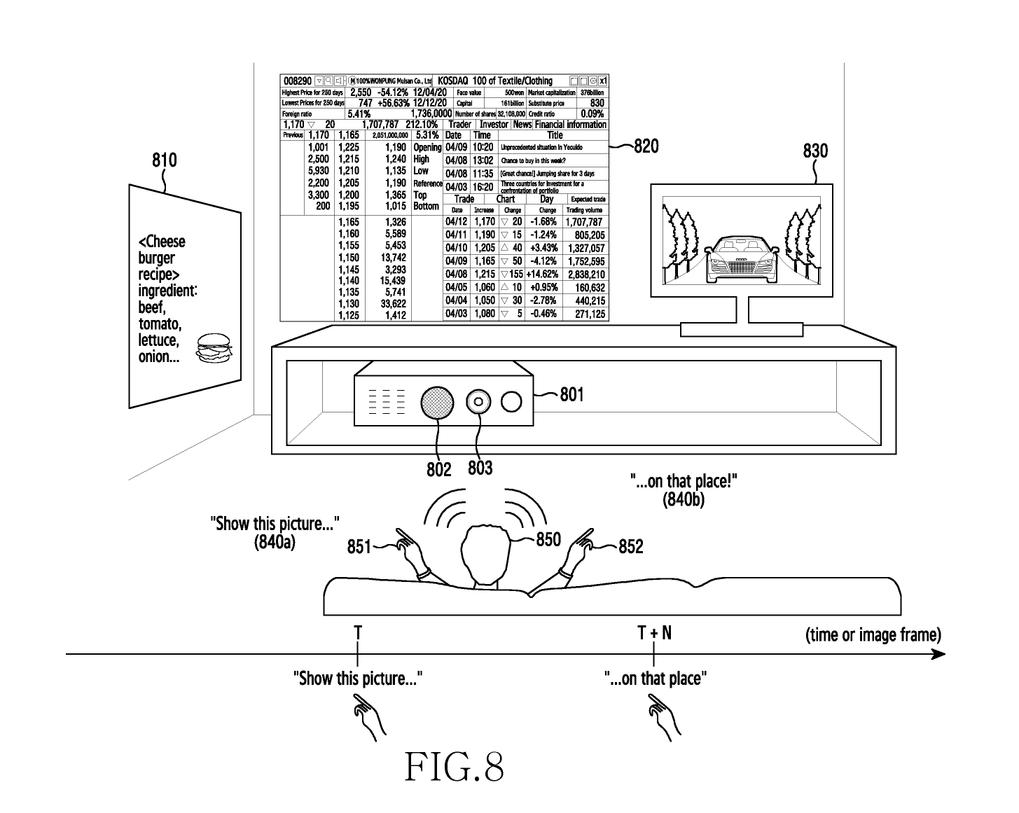

FIG. 8 illustrates a view showing a method for processing a user's input based on a content in an electronic device 801 according to various example embodiments. According to various example embodiments, the electronic device 801 may include an NLP module (for example, 520 of FIG. 5), a gesture recognition module (for example, 550 of FIG. 5), and a content management module (for example, 560 of FIG. 5), for example. The NLP module (for example, 520 of FIG. 5) may use synchronization between a voice signal and a gesture, and may grasp a meaning of the voice signal based on a content indicated by the gesture. According to various example embodiments, when the user 850 speaks “Show this picture on that place!” 840a, 840b, it may be unclear what (for example, what content) the words “this picture” and “that place” indicate. In the voice signal, “this picture” may occur at a time T seconds and “that place” may occur at T+N seconds.

The gesture recognition module (for example, 550 of FIG. 5) may analyze image frames at T second using a camera image, and may determine that the user 850 indicated a first display 810 with a first gesture (for example, a gaze, a head direction, or a hand motion) 851. In addition, the gesture recognition module may analyze image 10 frames at T+N second, and determine that the user indicated a second display 830 with a second gesture (for example, a gaze, a head direction, or a hand motion) 852. The gesture recognition module may transmit electronic device names (for example, a serial number of a display device) indicated by the gesture and time zones to the content management module 560, for example, in the format of <T second: first display 810>, <T+N second: second display 830>.

The content management module (for example, 560 of FIG. 5) may receive the gesture information of <T second: first display 810>, <T+N second: second display 830> from the gesture recognition module (for example, 550 of FIG. 5) based on pre-stored information <first display 810: cooking content>, <second display 830: car race content>. The content management module 560 may generate content information <T second: first display 810: cooking content>, <T+N second: second display 830: car race content> by considering both the pre-stored information and the received gesture information. The content management module 560 may transmit the generated content information to the NLP module 520.

The NLP module (for example, 520 of FIG. 5) may generate natural language processing information <T second: “this picture”: first display 810: cooking content>, <T+N second: “that place”: second display 830: car race content> based on the voice recognition information <T second: “this picture>, <T+N second: “that place”>, and the received content information <T second: first display 810: cooking content>, <T+N second: second display 830: car race content>. The NLP module 520 may limit (interpret) “this picture” to a meaning of a cooking content window, and limit (interpret) “that place” to a meaning of the second display 830 based on the generated natural language processing information.

The NLP module (for example, 520 of FIG. 5) may interpret the sentence “Show this picture on that place!” 840a, 840b as meaning “Show cooking content on the second display!” The NLP module 520 may determine a task and a parameter based on the interpreted meaning. The task may be “transmitting content,” for example, and the parameter may be “cooking content” displayed on the first display 810, for example. According to various example embodiments, the input processing module 501 may perform the task of “displaying the cooking-related content displayed on the first display 810 on the display 830” using a tool (for example, an API corresponding to a content transmitting task) based on the task and the parameter.

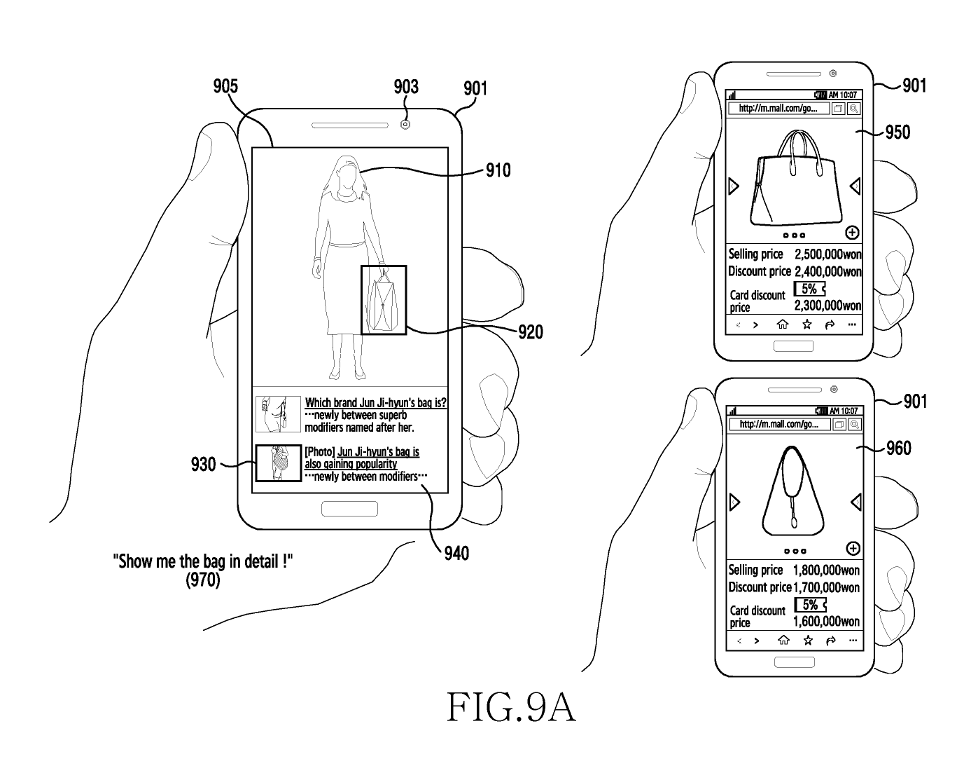

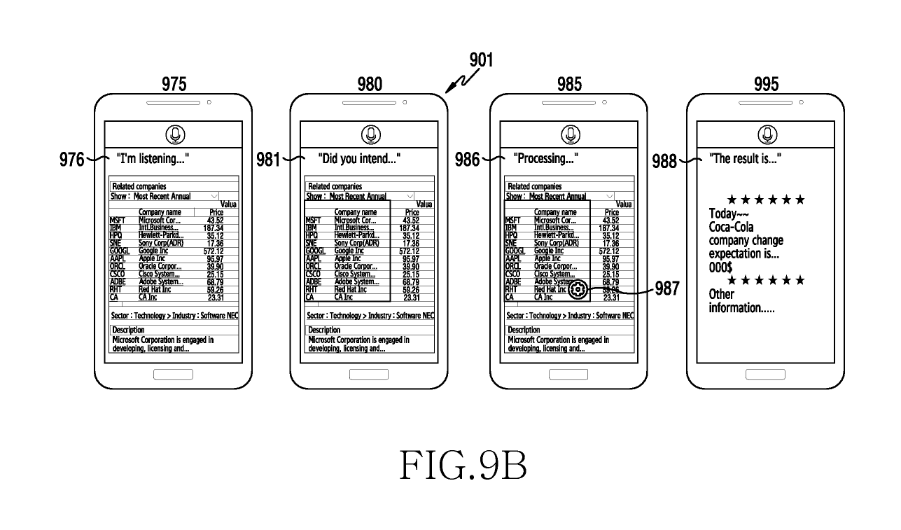

FIGS. 9A and 9B illustrate views illustrating a method for displaying a content in an electronic device 901 and a process of displaying a process of processing a user's input according to various example embodiments. According to various example embodiments, the electronic device 901 may be a smartphone.

Referring to FIG. 9A, the electronic device 901 may display a plurality of windows 910, 940 on an upper portion and a lower portion of a display 905 so that the plurality of windows 910, 940 are distinguished from each other. According to various example embodiments, the electronic device 901 may recognize that a user is gazing at the display 905 using a camera 903, for example. The electronic device 901 may recognize which of the plurality of windows 910, 940 the user is gazing at using the camera 903, for example. In addition, when it is recognized that the user is gazing at the first window 910 of the plurality of windows 910, 940, the electronic device 901 may additionally recognize which part of the first window 910 the user is gazing at. According to various example embodiments, when it is recognized that the user gazed at an object 920 in a moving image in the middle of viewing the moving image (TV drama) through the first window 910, and spoke “Show me the bag in detail!” 970, the electronic device 901 may recognize the object 920 based on display coordinates corresponding to the part that the user was gazing at, and acquire product tag information provided by additional information of the TV drama as information corresponding to the object 920. The electronic device 901 may recognize the meaning (for example, a brand, a size, a product name, etc.) of the “bag,” which is a part of the voice input, using the product tag information, and may determine a task corresponding to the voice input and a parameter related to the task. For example, the task may be “searching props,” and the parameter may be “brand” or “size.” The electronic device 901 may execute a “broadcasting station shopping mall application” tool using the task and the parameter, and perform the task “searching props” using the parameter “brand,” “product name,” or “size,” as a search term, and may visually display the result of the performing the task for the user (950). In addition, the electronic device may acoustically output the result of the performing the task to the user. Another example embodiment may be implemented.

According to various example embodiments, when it is recognized that the user gazed at an object 930 in a web page displayed through the second window 940 in the middle of surfing the web through the second window 940, and spoke “Show me the bag in detail!” 970, the electronic device 901 may recognize that the object indicated by “the bag,” which is a part of the voice input, is the object 930 in the web page of the second window 940 rather than the object 920 in the image of the first window 910. The electronic device 910 may visually distinguish and display the area of the object 930 selected by the user's gaze in the second window 940 (for example, by highlighting the rectangular border of the corresponding area). The content management module 560 may extract an additional set of characters using metadata of the object 930 in the web page of the window 940 where the web surfacing is performed, or may extract an additional set of characters from texts located around the object 930. The NLP module 520 may update the meaning of “the bag” by changing or complementing the meaning of “the bag” using the extracted additional set of characters, and determine a task based on the changed or complemented meaning and determine a parameter or a tool corresponding to the task.

According to various example embodiments, the task may be “searching product information,” and the parameter may be “product name,” “brand,” or “size.” The electronic device 901 may execute a web browser tool using the task and the parameter, and perform the task “searching product information” using the parameter “product name,” “brand,” or “size,” as a search term, and visually display the result of the performing the task for the user (960). The electronic device 901 may acoustically output the result of the performing the task to the user.

According to various example embodiments, the electronic device 901 may include a plurality of displays, for example. The plurality of displays may be located on the front surface, side surface, or rear surface of the electronic device 201. The respective displays may be hidden from the user's field of view or revealed in a folding method or a sliding method. According to various example embodiments, the electronic device 901 may display the windows (for example, 910, 940) on the plurality of displays. According to various example embodiments, the electronic device 901 may recognize which of the plurality of displays the user is looking at based on a user's gesture which is acquired using a camera (for example, 391 of FIG. 3). The electronic device 901 may recognize one of the plurality of displays that the user is looking at, and may process a user's voice signal based on a content displayed on one of the display windows 910 or 940.

Referring to FIG. 9B, the electronic device 901 may be a smartphone, and may visually show a process of processing a function corresponding to a user's voice signal input based on a content selected by a user's gesture (for example, a gaze). According to various example embodiments, in element 975, the electronic device 901 may activate a microphone (for example, the microphone 388 of FIG. 3), and may be prepared to receive a voice signal from the user and may visually display a sentence 976 “I'm listening . . . ”

When the user utters a voice “How much does this cost?,” the electronic device 901 may recognize which area (for example, top, bottom, left, left, right, and center) of the content displayed on the display the user is gazing at using the camera (for example, the camera module 391 of FIG. 3), and display the result of the recognition through the display. For example, the electronic device 901 may visually display a focus an object at which the user is gazing.

In addition, the electronic device 901 may execute OCR with respect to the object, and extract an additional set of characters “Coca-Cola Company” as a result of the OCR. As seen in element 980, the electronic device 901 may recognize the meaning of the set of characters “this” as “Coca-Cola Company” based on the result of the extraction, and may visually or acoustically output a confirmation message 981 to confirm whether the result of the extraction corresponds to a user's intention or not, for example, “Did you intend to search information about Coca-Cola company?,” to the user. In addition, when it is recognized that the user's gaze was fixed on another object (for example, “Pepsi company”) within a predetermined time range from the time at which the user's voice was uttered, the electronic device 901 may display a focus on another object, and may visually or acoustically output a sentence “Did you intend to search information about Pepsi company?” (not shown) to the user.

As seen in element 985, the electronic device 901 may visually display a sentence 986 “Processing . . . ” or an icon 987 indicating that the task is being performed for the user while the task of searching information on “Coca Cola Company” is being performed. As seen in element 995, when the task is completed, the electronic device 901 may display a sentence 988 “The result is . . . ” for the user to inform the result of the performing the task, and display a screen 995 including the result of the performing the task.

According to an example embodiment, an electronic device may include at least one sensor to detect a gesture, and an input processing module which is implemented by using a processor. The input processing module may be configured to: receive a voice input; detect the gesture in connection with the voice input using the at least one sensor; select at least one of contents displayed on at least one display functionally connected with the electronic device at least based on the gesture; determine a function corresponding to the voice input based on the at least one content; and, in response to the voice input, perform the function.

According to an example embodiment, the at least one sensor may include a camera.

According to an example embodiment, the input processing module may receive the voice input from an external electronic device for the electronic device.

According to an example embodiment, the input processing module may be configured to convert at least part of the voice input into a set of characters.

According to an example embodiment, the input processing module may be configured to disregard a gesture which is detected beyond a predetermined time range from a time at which the voice input is received.

According to an example embodiment, the input processing module may be configured to recognize at least one of a plurality of speakers as a speaker of the voice input based on the gesture.

According to an example embodiment, the input processing module may be configured to identify a window displaying the content from among a plurality of windows displayed on the at least one display based on the gesture.

According to an example embodiment, the at least one display may include a plurality of displays including a first display and a second display, and the input processing module may be configured to identify a display displaying the content from among the plurality of displays based on the gesture.

According to an example embodiment, the input processing module may be configured to, when the at least one content includes a first content, determine a first function as the function, and, when the at least one content includes a second content, determine a second function as the function.

According to an example embodiment, the input processing module may be configured to: convert at least part of the voice input into a set of characters; update at least part of the set of characters based on the at least one content; and determine the function based on the updated set of characters.

According to an example embodiment, the input processing module may be configured to determine a set of characters corresponding to at least part of the at least one content, and determine the function additionally based on the set of characters.

According to an example embodiment, the input processing module may be configured to determine whether the set of characters includes a meaning relation structure between at least one first concept and at least one second concept, and update another set of characters corresponding to at least part of the voice input based on the meaning relation structure.

According to an example embodiment, the input processing module may be configured to determine a subject related to the at least one content, and determine the function based on the subject.

According to an example embodiment, the input processing module may be configured to determine first relevance of the at least one content to a first function and second relevance of the at least one content to a second function, and determine a function corresponding to higher relevance of the first relevance and the second relevance as the function.

According to an example embodiment, the input processing module may be configured to determine the function additionally based on one or more of an application in use, location information, environment information, or an available peripheral device.

According to an example embodiment, the input processing module may be configured to highlight a representation corresponding to at least one of the receiving the voice input, the selecting the at least one content, or the performing the function through the display.

According to an example embodiment, the input processing module may be configured to determine the function additionally based on an acoustic attribute related to the voice input.

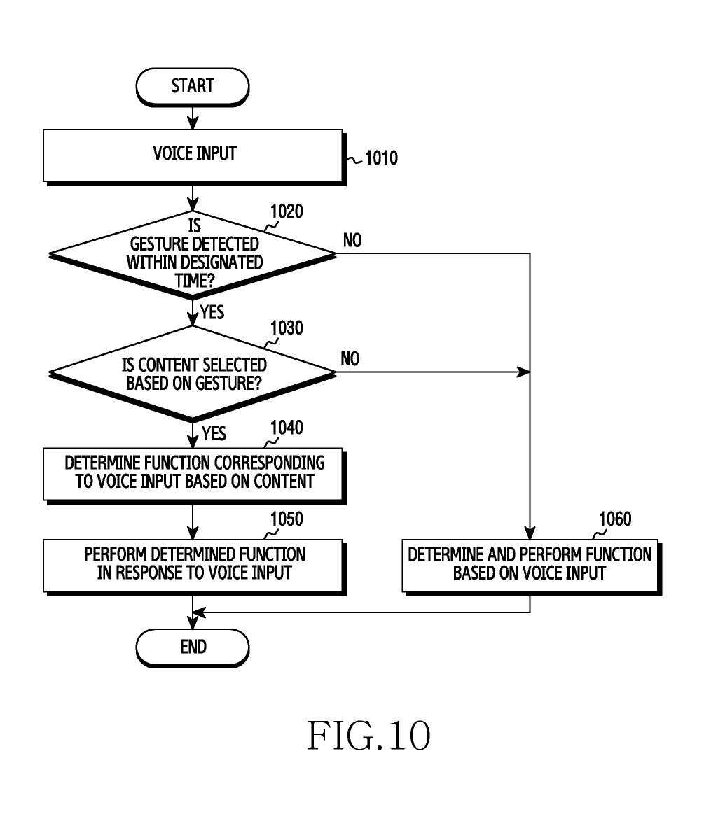

FIG. 10 illustrates a flowchart showing a method for processing a user's input based on a content in an electronic device according to various example embodiments. In operation 1010, the electronic device 201 (or the input processing module 501 of the electronic device 201) may receive a voice signal using an audio input device (for example, the microphone 102, 107 of FIG. 1). In operation 1020, the electronic device 201 (or the input processing module 501 of the electronic device 201) may recognize user's gesture information (for example, a location, a face, a head direction, a gaze, or a hand motion) based on an image which is photographed by a camera (for example, 103, 105 of FIG. 1). In operation 1030, the electronic device 201 (or the input processing module 501 of the electronic device 201) may recognize a content that is indicated by the user from among or based on the contents displayed on the display (for example, 110, 120, 130 of FIG. 1) using the user's gesture information. In operation 1040, the electronic device 201 (or the input processing module 501 of the electronic device 201) may determine a function (for example, a task, a parameter, a tool) corresponding to the user's voice signal based on the content indicated by the user. In operation 1050, the electronic device 201 (or the input processing module 501 of the electronic device 201) may respond to the voice signal of the user by performing the determined function. In operation 1060, when a gesture is not detected in operation 1020 or a content is not selected in operation 1030, the electronic device (or the input processing module 501 of the electronic device 201) may determine a function based on the voice signal input and process the function, or may not determine the function in operation 1060.

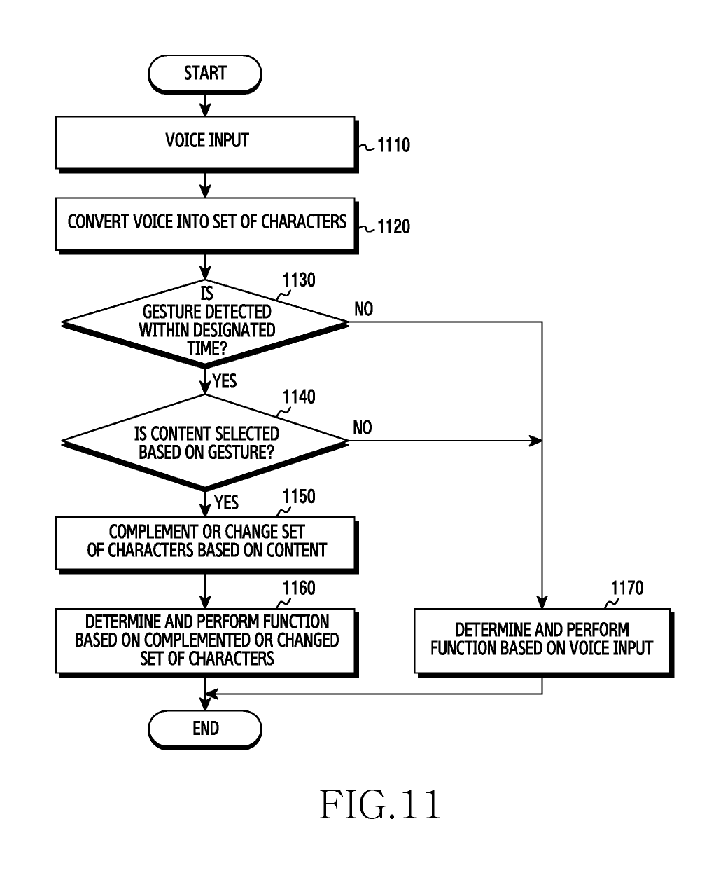

FIG. 11 illustrates a flowchart showing a method for processing a user's input based on a content in an electronic device according to various example embodiments. In operation 1110, the electronic device 201 (or the input processing module 501 of the electronic device 201) may receive a voice signal using an audio input device (for example, the microphone 102, 107 of FIG. 1). In operation 1120, the electronic device 201 (or the input processing module 501 of the electronic device 201) may convert the voice signal into a set of characters. In operation 1130, the electronic device 201 (or the input processing module 501 of the electronic device 201) may recognize user's gesture information (for example, a location, a face, a head direction, a gaze, or a hand motion) based on an image which is photographed by a camera (for example, 103, 105 of FIG. 1). In operation 1140, the electronic device 201 (or the input processing module 501 of the electronic device 201) may recognize a content that is indicated by the user from among or based on the contents displayed on the display (for example, 110, 120, 130 of FIG. 1) using the user's gesture information. In operation 1150, the electronic device 201 (or the input processing module 501 of the electronic device 201) may update (or complement or change) the set of characters based on the content indicated by the user. In operation 1160, the electronic device 201 (or the input processing module 501 of the electronic device 201) may determine a function corresponding to the user's voice signal based on the updated set of characters, and perform the function. When a gesture is not detected in operation 1130 or a content is not selected in operation 1140, the electronic device 201 (or the input processing module 501 of the electronic device 201) may determine a function based on the voice signal input and process the function, or may not determine the function in operation 1170.

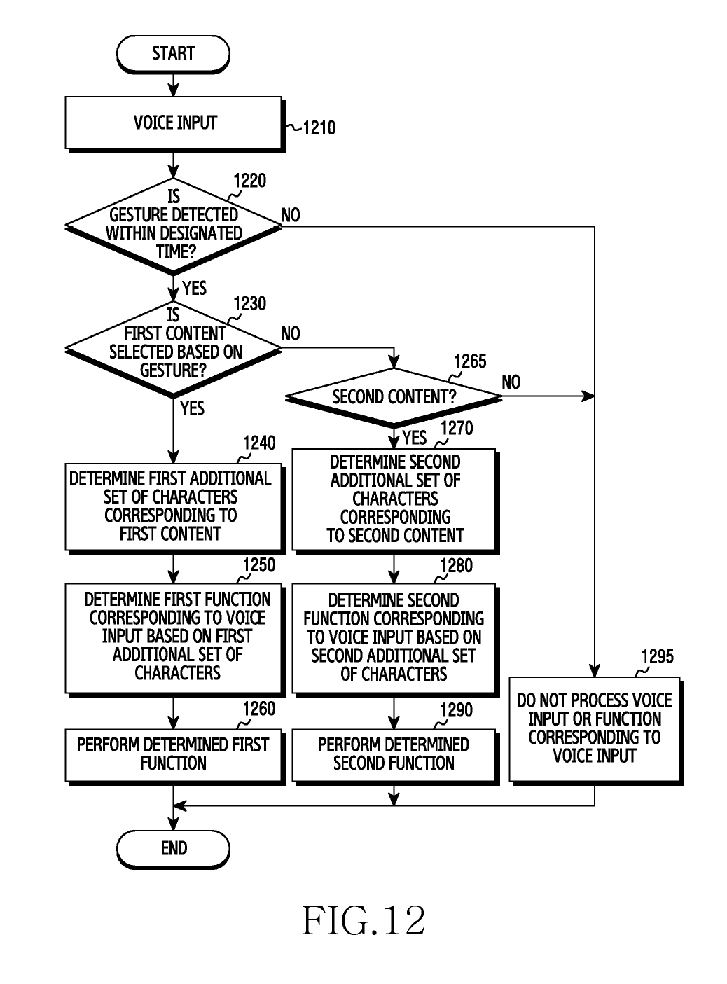

FIG. 12 illustrates a flowchart showing a method for processing a user's input based on a content in an electronic device according to various example embodiments.

In operation 1210, the electronic device 201 (or the input processing module 501 of the electronic device 201) may receive a voice signal using an audio input device (for example, the microphone 102, 107 of FIG. 1). In operation 1220, the electronic device 201 (or the input processing module 501 of the electronic device 201) may determine whether a gesture is detected within a designated time. If the gesture is detected, the electronic device 201 may recognize user's gesture information (for example, a location, a face, a head direction, a gaze, or a hand motion) corresponding to the detected gesture. For example, the electronic device 201 may recognize the user's gesture information using an image which is photographed by a camera (for example, 103, 105 of FIG. 1). In operation 1230, the electronic device 201 (or the input processing module 501 of the electronic device 201) may determine whether a content indicated by the user from among the contents displayed on the display (for example, 110, 120, 130 of FIG. 1) is a first content or not (e.g., whether the content is selected) using the user's gesture information.

When the electronic device 201 (or the input processing module 501 of the electronic device 201) determines that the content indicated by the user is selected as the first content in operation 1230, in operation 1240, the electronic device 201 (or the input processing module 501 of the electronic device 201) may determine a first additional set of characters corresponding to the first content indicated by the user. In operation 1250, the electronic device 201 (or the input processing module 501 of the electronic device 201) may determine a first function corresponding to the voice signal based on the first additional set of characters. In operation 1260, the electronic device 201 (or the input processing module 501 of the electronic device 201) may respond to the voice signal by performing the determined first function.

When the electronic device 201 (or the input processing module 501 of the electronic device 201) determines that the content indicated by the user is a second content in operation 1265, in operation 1270, the electronic device 201 (or the input processing module 501 of the electronic device 201) may determine a second additional set of characters corresponding to the second content indicated by the user. In operation 1280, the electronic device 201 (or the input processing module 501 of the electronic device 201) may determine a second function corresponding to the voice signal based on the second additional set of characters. In operation 1290, the electronic device 201 (or the input processing module 501 of the electronic device 201) may respond to the voice signal of the user by performing the determined second function.

When a gesture is not detected in operation 1220 or when the first content is not selected in operation 1230 or the second content is not selected in operation 1265, the electronic device 201 (or the input processing module 501 of the electronic device 201) may determine a function based on the voice signal input and process the function, or may not determine the function in operation 1295.

The operations described in the process or method illustrated in FIGS. 10 to 12 (for example, 1010-1060, 1110-1170, or 1210-1295 may be performed in sequence, in parallel, repeatedly, or heuristically. In addition, the operations may be performed in a different order, some operation may be omitted, or other operations may be added.

According to an example embodiment, a method for operating in an electronic device may include: receiving a voice input; detecting a gesture in connection with the voice input; selecting at least one of contents displayed on at least one display functionally connected with the electronic device at least based on the gesture; determining a function corresponding to the voice input based on the at least one content; and in response to the voice input, performing the function. According to an example embodiment, the method may further include receiving the voice input from an external electronic device for the electronic device.

According to an example embodiment, the receiving may include converting at least part of the voice input into a set of characters.

According to an example embodiment, the detecting may include disregarding a gesture which is detected beyond a predetermined time range from a time at which the voice input is received.

According to an example embodiment, the detecting may include recognizing at least one of a plurality of speakers as a speaker of the voice input based on the gesture.

According to an example embodiment, the selecting may include identifying a window displaying the content from among a plurality of windows displayed on the at least one display based on the gesture.

According to an example embodiment, the at least one display may include a plurality of displays including a first display and a second display, and the selecting may include identifying a display displaying the content from among the plurality of displays based on the gesture.

According to an example embodiment, the determining may include: when the at least one content includes a first content, determining a first function as the function; and, when the at least one content includes a second content, determining a second function as the function.

According to an example embodiment, the determining may include: converting at least part of the voice input into a set of characters; updating at least part of the set of characters based on the at least one content; and determining the function based on the updated set of characters.

According to an example embodiment, the determining may include: determining a subject related to the at least one content; and determining the function based on the subject.

According to an example embodiment, the determining may include: determining first relevance of the at least one content to a first function and second relevance of the at least one content to a second function; and determining a function corresponding to higher relevance of the first relevance and the second relevance as the function.

According to an example embodiment, the determining may include determining the function additionally based on one or more of an application in use, location information, environment information, or an available peripheral device.

According to an example embodiment, the determining may include determining the function additionally based on an acoustic attribute related to the voice input.

According to an example embodiment, the performing may include: determining a set of characters corresponding to at least part of the at least one content; and determining the function additionally based on the set of characters.

According to an example embodiment, the performing may include: determining whether the set of characters includes a meaning relation structure between at least one first concept and at least one second concept; and updating another set of characters corresponding to at least part of the voice input based on the meaning relation structure.

According to an example embodiment, the performing may include highlighting a representation corresponding to at least one of the receiving the voice input, the selecting the at least one content, or the performing the function through the display.

According to an example embodiment, in a recording medium which stores instructions, the instructions are set for at least one processor to perform at least one operation when the instructions are executed by the at least one processor. The at least one operation may include: receiving a voice input; detecting a gesture in connection with the voice input; selecting at least one of displayed contents based on the gesture; and, in response to the voice input, performing a function which is determined at least based on the at least one content.

The electronic device according to an example embodiment to achieve the above-described objects or other objects may determine a function corresponding to a user's voice input based on a content selected by the user, and may complement or change a meaning corresponding to the user's voice input, and thus can perform a function closer to a user's intention. In addition, the electronic device may display the process of performing the function corresponding to the user's voice input visually or acoustically.

The term “module” used in the present document may represent, for example, a unit including a combination of one or two or more of hardware, software, or firmware. The “module” may be, for example, used interchangeably with the terms “unit”, “logic”, “logical block”, “component”, or “circuit” etc. The “module” may be the minimum unit of an integrally implemented component or a part thereof. The “module” may be also the minimum unit performing one or more functions or a part thereof. The “module” may be implemented mechanically or electronically. For example, the “module” may include at least one of an Application-Specific Integrated Circuit (ASIC) chip, Field-Programmable Gate Arrays (FPGAs) and a programmable-logic device performing some operations known to the art or to be developed in the future.

At least a part of an apparatus (e.g., modules or functions thereof) or method (e.g., operations) according to various example embodiments may be, for example, implemented as instructions stored in a computer-readable storage medium in a form of a programming module. In case that the instruction is executed by a processor (e.g., processor 220), the processor may perform functions corresponding to the instructions. The computer-readable storage media may be the memory 230, for instance.

The computer-readable recording medium may include a hard disk, a floppy disk, and a magnetic medium (e.g., a magnetic tape), an optical medium (e.g., a Compact Disc-Read Only Memory (CD-ROM) and a Digital Versatile Disc (DVD)), a Magneto-Optical Medium (e.g., a floptical disk), and a hardware device (e.g., a Read Only Memory (ROM), a Random Access Memory (RAM), a flash memory, etc.). Also, the program instruction may include not only a mechanical language code such as a code made by a compiler but also a high-level language code executable by a computer using an interpreter, etc. The aforementioned hardware device may be implemented to operate as one or more software modules in order to perform operations of various example embodiments, and vice versa.

The module or programming module according to various example embodiments may include at least one or more of the aforementioned elements, or omit some of the aforementioned elements, or further include additional other elements. Operations carried out by the module, the programming module or the other elements according to various example embodiments may be executed in a sequential, parallel, repeated or heuristic method. Also, some operations may be executed in different order or may be omitted, or other operations may be added.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”. In addition, an artisan understands and appreciates that a “processor” or “microprocessor” may be hardware in the claimed disclosure. Under the broadest reasonable interpretation, the appended claims are statutory subject matter in compliance with 35 U.S.C. §101.

What is claimed is:

1. A method in an electronic device, comprising:
receiving a voice input;
detecting a gesture associated with the voice input;
selecting at least one content displayed on one or more displays functionally connected with the electronic device based on the detected gesture;
determining a function corresponding to the voice input based on the selected at least one content; and
executing the determined function.

2. The method of claim 1, wherein the voice input is received from an external electronic device communicatively coupled with the electronic device.

3. The method of claim 1, wherein receiving the voice input further comprises converting at least a portion of the voice input into a set of characters.

4. The method of claim 1, wherein detecting the gesture further comprises disregarding any gesture detected beyond a predetermined time range from a time the voice input is initially received.

5. The method of claim 1, further comprising detecting, based on the detected gesture, at least one of a plurality of speakers associated with the voice input.

6. The method of claim 1, wherein selecting the at least one content further comprises identifying, based on the detected gesture, a window including the displayed content from among a plurality of windows displayed on the one or more displays.

7. The method of claim 1, wherein the one or more displays comprises a plurality of displays, and
wherein selecting the at least one content comprises identifying, based on the detected gesture, a particular display from among the plurality of displays displaying the selected at least one content.

8. The method of claim 1, wherein executing the determined function further comprises:
extracting from the selected at least one content a set of characters corresponding to at least a portion of the selected at least one content; and
determining the function corresponding to the voice input based on the extracted set of characters.

9. The method of claim 8, wherein executing the determined function further comprises:
determining whether the extracted set of characters comprises a meaning relation structure between at least one first concept and at least one second concept; and
updating another set of characters corresponding to at least part of the voice input utilizing the meaning relation structure.

10. The method of claim 1, wherein executing the determined function further comprises displaying information corresponding to the executed determined function based on the selected at least one content.

11. An electronic device comprising:
at least one sensor configured to detect a gesture; and
at least one processor coupled to a memory, configured to:
receive a voice input;
detect, via the at least one sensor, a gesture associated with the received voice input;
select at least one content displayed on one or more displays functionally connected with the electronic device based on the detected gesture;
determine a function corresponding to the voice input based on the selected at least one content; and
execute the determined function.

12. The electronic device of claim 11, wherein the at least one sensor comprises a camera or a microphone.

13. The electronic device of claim 11, wherein:
the determined function comprises a first function when the selected at least one content is of a first content type; and
the determined function comprises a second function, different, than the first function, when the selected at least one content comprises a second content type.

14. The electronic device of claim 11, wherein the at least one processor is further configured to:
convert at least part of the voice input into a set of characters;
update at least part of the set of characters based on the at least one content selected from the one or more displays; and
determine the function corresponding to the voice input based on the updated at least part of the set of characters.

15. The electronic device of claim 11, wherein the at least one processor is further configured to:
parsing the voice input to determine a portion of the voice input indicating a grammatical subject related to the selected at least one content displayed on the one or more displays,
wherein determining the function corresponding to the voice input is at least partially based on the indicated grammatical subject.

16. The electronic device of claim 11, wherein determining the function further comprises:
retrieve from the memory a first relevance value of a first function to the selected at least one content and a second relevance value of a second function to the selected at least one content; and
select the first function or the second function as the determined function according to a comparison of the first relevance value to the second relevance value.

17. The electronic device of claim 11, wherein determining the function based on, in addition to the selected at least one content, one or more of an application in use, location information, environment information, or an available peripheral device.

18. The electronic device of claim 11, wherein the at least one processor is further configured to:
control a display unit to display a graphic effect highlighting a region or displayed object corresponding to at least one of the received voice input, the selected at least one content, or the executed determined function.

19. The electronic device of claim 11, wherein determining the function corresponding to the voice input is further based on an acoustic attribute related to the voice input.

20. A non-transitory computer-readable recording medium in an electronic device, which records a program executable by a processor to:
receive a voice input;
detect, via at least one sensor, a gesture associated with the voice input;
select at least one content displayed on one or more displays functionally connected with the electronic device based on the gesture; and
determine a function corresponding to the voice input based on the selected at least one content and executed the determined function.
